(19) United States
(12) Patent Application Publication
(10) Pub. No.: US 2026/0358589 A1
(43) Pub. Date: Nov. 12, 2026

(54) CO-PACKAGED OPTICS (CPO) SHUFFLE-TRAY ASSEMBLY AND SHUFFLE CASSETTES THEREOF

(71) Applicant: Mellanox Technologies, Ltd., Yokneam (IL)

(72) Inventors: Moti CABESSA, Ramat-Gan (IL); Gal BARUCH, Yokneam (IL); Efi ROIF, Gan Yavne (IL); Amit OREN, Ramat Hasharon (IL); Hila HAZENSHPRUNG, Tirat Yehuda (IL)

(21) Appl. No.: 19/365,568

(22) Filed: Oct. 22, 2025

Related U.S. Application Data
(60) Provisional application No. 63/804,329, filed on May 12, 2025.

(51) Int. Cl. G02B 6/44

(52) U.S. Cl. CPC G02B 6/4446; G02B 6/4453

(57) ABSTRACT

A optical connector box includes a plurality of first optical connection mating components; a plurality of second optical connection mating components; a plurality of optical fibers each configured to place a respective channel of a first optical connection mating component with a respective channel of a second optical connection mating component; and a cassette housing including a front panel, a back panel that is opposite the front panel, and defining a volume between the front panel and the back panel. The plurality of first optical connection mating components are disposed on the front panel, the plurality of second optical connection mating components are disposed on the back panel, and the plurality of optical fibers are disposed within the volume. The optical connector box may be installed in a CPO shuffle-tray assembly including independent trays.

### CROSS-REFERENCE TO RELATED APPLICATIONS

This application claims priority to U.S. Application No. 63/804,329, filed May 12, 2025, the content of which is incorporated herein by reference in its entirety.

### BACKGROUND

As artificial intelligence and/or machine learning use increases, the amount of information being communicated between large clusters of computing resources (e.g., graphical processing units (GPUs), central processing units (CPUs), data processing units (DPUs), and/or the like) is also increasing. Links between computing resources and/or chips thereof are based on copper cables (short reach) or optical cables. In the optical cables, the data to be transferred between chips (or switches) is encoded/decoded from electrical to optical signal (and vice versa) and conveyed via an optical fiber. For optical connections, optical switches encompass computing resources to distribute data packets among a plurality of optical channels to multiple receivers. Historically, optical components have been provided separately from computing resources, and so the physical size of the combination of optical components and separate computing resources has been one of the limiting factors in data center designs. However, with the introduction of co-packaged optics (CPO) designs including optics and computing resources, the combined size of optics and computing resources is relatively small, and other physical devices have become larger contributors to size limitations in data center designs, including shuffle solutions for connecting fibers with computing resources. Therefore, there is a need in the art for compact shuffle cassette configurations and co-packaged optical (CPO) configurations that enable connection between many optical fibers with one or more computing resources.

### GENERAL DESCRIPTION

The physical size of optical connectors at a CPO component is increasingly becoming a limiting factor in data center design, as the size the CPO components themselves decrease. Moreover, some datacenter designs require additional adapters at the optical connectors to accommodate different connector types, which further exacerbates the spatial concerns of including the necessary connectors and adapters of CPO components. The size of these optical connectors (and adapters) becomes difficult to accommodate as the size of the CPO components decreases. Therefore, there is a need to provide efficient routing between computing resources of a CPO component and other components of a datacenter.

Moreover, as the number of optical connections within a given system increases, the likelihood of a system component failure occurring increases. Manufacturing yield drops significantly, as a single defective fiber can render the entire expensive assembly useless. Furthermore, such large, integrated units are difficult to service, clean, or debug in the field. Therefore the robustness or reliability of the CPO component may be improved by enabling individual components of the CPO component to be independently serviced.

In various embodiments, the optical fibers used to provide connectivity between computing resources of a CPO component and other computing resources of the datacenter may include multiple fiber types (e.g., single mode fibers (SMF) for connection with the computing resources and polarization maintaining fibers (PMF) for connection with external laser source small form factor pluggable (ELSFP) connections.

The challenge is routing the fibers from the trays hosting the computing resources to the front panel in a way that each connection point connects to the correct fibers. The trays of the CPO component have many fibers extending therefrom, and so collectively the optical system of the CPO component may include over 4,000 optical fibers. This requires that each pair of transmitter and receiver fibers is connected to a dedicated channel of a respective tray hosting a respective computing resource. The shuffle cassettes discussed herein manage the complex routing and ensures that fibers are correctly connected without mixing them up, thereby solving the meshing challenge.

The disclosed systems and methods may be implemented using co-packaged optical (CPO) solutions integrated with electronic switch ASICs, network processors, or AI accelerators. Optical components such as modulators, drivers, photodetectors, and laser sources may be co-packaged directly on or near the host silicon using advanced packaging technologies including 2.5D interposers or silicon bridges.

In some configurations, mid-board optical modules (MBOMs) are employed as part of the optical I/O strategy. MBOMs are positioned centrally on the PCB—between the front panel and the host die—enabling shorter electrical traces and improved signal integrity while maintaining separation between optics and high-power ASICs for thermal management.

Near-packaged optics may also be used, placing optical engines in close proximity to the host device without full co-packaging, allowing for modular deployment and gradual migration from pluggable optics.

The system may support optical connectivity through edge couplers, fiber ribbon interfaces, or on-board photonic waveguides. Silicon photonics may be used to implement optical engines within the CPO or MBOM units, with support for modulation schemes such as PAM4, coherent signaling, or WDM.

These components may be interconnected via high-speed electrical interfaces such as SerDes lanes, and coordinated via on-board controllers that handle lane training, optical power tuning, and health monitoring.

Embodiments may scale from 400G to 1.6T and beyond, supporting deployment in high-performance computing, AI clusters, and data center switching platforms. Integration strategies may include air-cooled and liquid-cooled packages, supporting advanced thermal designs to handle the combined electrical and optical power densities.

The system may be implemented in modular switch platforms, AI training fabrics, or other environments requiring high-density, low-latency interconnect.

Moreover, the shuffle cassettes disclosed herein enable the trays and shuffle cassettes of a CPO component, such as a CPO shuffle-tray assembly, to be independently removed from the CPO component for cleaning, testing, servicing, and/or replacement.

An optical shuffle cassette as discussed herein is a “many-to-many” optical connector shuffle cassette having a front panel with a plurality of optical connectors (e.g., 8- 12- or 16-fiber MPO/MTP connectors) that detachably connects with a plurality of optical I/O computing resources (e.g., CPO computing resources, such as CPO switchboards (e.g., 4 CPO switchboards)) using a plurality of optical backplane connectors rigidly secured within a back panel of the shuffle cassette (opposite the customer interface). A plurality of shuffle cassettes may be included in a CPO component, such as a CPO shuffle-tray assembly. The shuffle cassettes provide the same design for different footprints. When the connection point connects to 8 fibers, 4 fibers are transmitters and 4 fibers are receivers. These shuffle cassettes enclose the necessary connections for providing customer-accessible connection adapters to the optical I/O switchboards in a compact arrangement that addresses the foregoing spatial concerns of connectors at optical I/O switchboards, while also maintaining an ability to connect different optical shuffle box configurations relative to the optical I/O switchboards. The connectors on the front view are customer ports, which allow customers to access all switches, trays, and ASICS using a single port. The back of the trays has electrical and liquid connections for easy replacement of damaged units. These shuffle cassettes address the complexity by handling the fiber matrix within a plurality of separate mechanical housings. Connectors of a housing are attachable to connectors of the optical I/O computing resources with a simple click, minimizing assembly errors, and the cassette housing can be secured to a tray of the optical I/O switch with guide pins and/or fasteners to mechanically secure the housing of the shuffle cassette with the optical I/O tray. In an example embodiment, a shuffle cassette is mechanically secured into a CPO component via the coupling of a plurality of second optical connection mating components of the shuffle cassette with optical backplane mating connectors of one or more trays of the CPO component.

The optical backplane mating connectors of a tray are part of an optical backplane of the tray. An optical backplane is a circuit board with a group of optical connectors (e.g., optical backplane mating connectors) in parallel with each other, so that each signal connection of each connector is linked with optical interconnection. It is used as a backbone to connect several optical daughter boards (which may be disposed on various trays) together to make up a complete computer, switch, or server system.

In the described shuffle cassette, the plurality of optical backplane connectors are arranged in a backplane array on the back panel, such as one or more columns, where the columns are aligned in a first direction. Each optical connection mating component is an optical adapter connector that is configured for connection with a corresponding optical cable; for example, an optical adapter includes fibers that connect to each of a plurality of optical backplane connectors that connect with mating connectors on a plurality of optical I/O computing resources, such as optical I/O switchboards (or on fibers/cables that lead to the optical I/O switchboards). In some embodiments, each cassette also has an associated external laser source plug leading to the plurality of optical backplane connectors.

The single large shuffle box is broken down into multiple smaller, independent cassettes. Each shuffle cassette can be independently disconnected from the optical I/O computing resources, by physically removing the shuffle cassette, thereby detaching the optical backplane connectors securing the shuffle box with an assembly housing of the CPO component (e.g., a CPO shuffle-tray assembly). The size of the shuffle cassette can be scaled as needed, and the types of optical adapters can be changed (e.g., by replacing the shuffle cassette) as needed to offer the flexibility to be replaced to meet varying requirements. The replaceable shuffle cassette allows for fast assembly and direct integration in the system, enables the shuffle cassette to be tested separately, prevents human errors during assembly, and reduces the overall volume of the entire setup. This approach enables: testing each shuffle cassette and tray independently before integration and customizing different planarization architectures and adapter types without altering the overall system design.

The CPO shuffle-array assembly configuration allows for customization of the front panel connectors. For example, customers can choose different types of connectors without redesigning the entire system, making it a flexible solution for various requirements. The use of an optical backplane connector enables the simple assembly and disassembly of the shuffle cassette from the system.

Certain embodiments are directed to a shuffle cassette or an optical connector box. For example, a shuffle cassette or an optical connector box may include a plurality of first optical connection mating components; a plurality of second optical connection mating components; and a plurality of optical fibers. Each optical fiber is configured to place a respective channel of a first optical connection mating component of the plurality of first optical connection mating components with a respective channel of a second optical connection mating component of the plurality of second optical connection mating components. The shuffle cassette further includes a cassette housing comprising a front panel and a back panel that is opposite the front panel. The cassette housing defines a volume disposed between the front panel and the back panel. The plurality of first optical connection mating components are disposed on the front panel, the plurality of second optical connection mating components are disposed on the back panel, and the plurality of optical fibers are disposed within the volume.

In an example embodiment, the plurality of first optical connection mating components are arranged as one or more first aligned columns of connection mating components on the front panel and the plurality of second optical connection mating components are arranged as one or more second aligned columns of connection mating components on the back panel.

In an example embodiment, the one or more first aligned columns of connection mating components defines a first direction and the front panel has a width in a direction perpendicular to the first direction that is at most 20 mm.

In an example embodiment, the plurality of second optical connection mating components are blind mate connectors. The interface between the trays and the cassettes may utilize blind-mate optical backplane connectors, which enables the "slide-in, slide-out" modularity without requiring manual connection of fiber arrays in a hard-to-access area.

In an example embodiment, the plurality of first optical connection mating components comprises a plurality of multi-fiber push on (MPO) connectors and the plurality of second optical connection mating components comprises a plurality of MXC connectors.

In an example embodiment, the plurality of second optical connection mating components is configured for being placed into optical communication with respective optical backplanes of one or more computing resource trays.

According to certain embodiments, a co-packaged optics (CPO) shuffle-tray assembly is provided. A CPO shuffle-tray assembly may include one or more trays and one or more shuffle cassettes. Each tray hosts a computing resource and includes one or more optical backplane mating connectors. The one or more optical backplane mating connectors of the one or more trays are configured to mate with respective second optical connection mating components of the plurality of second optical connection mating components.

In an example embodiment, each tray of the one or more trays comprises a respective busbar connector and a respective cooling sub-system.

In an example embodiment, each tray of the one or more trays is electrically, optically, and mechanically independent from a remainder of the one or more trays.

In an example embodiment, the one or more shuffle cassettes are configured to place respective computing resources of the one or more trays into optical communication with the plurality of first optical connection mating components.

In an example embodiment, the one or more trays are configured to be aligned with one another in a tray column arranged in a first direction, each of the one or more shuffle cassettes are aligned with the tray column, and the one or more shuffle cassettes are arranged in a cassette row aligned in a second direction that is perpendicular to the first direction.

In an example embodiment, the one or more trays are configured to be aligned with one another in tray column in a first direction such that the one or more optical backplane mating connectors of the one or more trays are arranged into one or more columns of optical backplane mating connectors.

In an example embodiment, the plurality of second optical connection mating components of the shuffle cassette of the one or more shuffle cassettes are arranged in one or more columns of optical connection mating components with one or more columns oriented in the first direction.

In an example embodiment, the CPO shuffle-tray assembly further includes assembly housing. The assembly housing includes a first sidewall; a second sidewall; and a floor component mechanically coupling the first sidewall and the second sidewall. The first sidewall, the second sidewall, and the floor component define an interior of the assembly housing. The one or more trays are configured to be stacked in a first portion of the interior of the assembly housing such that busbar connectors of the one or more trays extend out from the interior of the assembly housing. The one or more shuffle cassettes are configured to be disposed in a second portion of the interior of the assembly housing.

In an example embodiment, at least one tray comprises one or more cooling ports disposed along a same edge of the at least one tray as a busbar connector of the at least one tray and the assembly housing is configured to enable access to the one or more cooling ports.

In an example embodiment, the assembly housing, the one or more shuffle cassettes, and the one or more trays are configured such that each tray of the one or more trays is removable from the assembly housing without removing any of the one or more shuffle cassettes and without removing any other trays from the assembly housing and without un-mating a second optical connection mating component-optical backplane mating connector connections of any other of the one or more trays.

In an example embodiment, the assembly housing, the one or more shuffle cassettes, and the one or more trays are configured such that each shuffle cassette of the one or more shuffle cassettes is removable from the assembly housing without removing any of the one or more trays and without removing any other shuffle cassettes from the assembly housing and without un-mating a second optical connection mating component-optical backplane mating connector connections of any other of the one or more shuffle cassettes.

In an example embodiment, the assembly housing is configured to be positioned in a rack such that the busbar connectors of the one or more trays are coupled to a busbar of the rack.

In an example embodiment, at least one tray of the one or more trays comprises an extension portion that extends into the second portion of the interior of the assembly housing.

In an example embodiment, the extension portion of the at least one tray extends between two sets of shuffle cassettes.

In an example embodiment, the extension portion of the at least one tray comprises a user interface.

In an example embodiment, the user interface comprises one or more indicator lights.

In an example embodiment, the CPO shuffle-tray assembly further includes an access panel extending between the first sidewall and the second sidewall, wherein the access panel comprises one or more openings configured to permit access to the plurality of first optical connection mating components and providing access to the user interface.

In an example embodiment, the assembly housing is configured to enable a shuffle cassette of the one or more shuffle cassettes to be independently slid out of the assembly housing and/or to enable a tray of the one or more trays to be independently slid out of the assembly housing.

In an example embodiment, the computing resource is an ASIC and/or the CPO shuffle-tray assembly is an ASIC switch.

According to certain embodiments, a datacenter is provided that includes one or more CPO shuffle-tray assemblies.

### BRIEF DESCRIPTION OF THE SEVERAL VIEWS OF THE DRAWINGS

For a better understanding of embodiments of the disclosure and to show how the same may be carried into effect, reference will now be made, purely by way of example, to the accompanying drawings in which like numerals designate corresponding elements or sections throughout. In the accompanying drawings:

FIG. 1A shows a side view of an example shuffle cassette, according to an embodiment;

FIG. 1B shows a front view of the example shuffle cassette shown in FIG. 1A;

FIG. 2A provides a perspective view of example shuffle cassettes configured for interacting with and/or coupling to a single tray (e.g., a single ASIC), according to an example embodiment;

FIG. 2B provides a perspective view of example shuffle cassettes configured for interacting with and/or coupling to multiple trays (e.g., multiple ASICs), according to an example embodiment;

FIG. 3A schematically illustrates the connections between connection points and connectors within a shuffle cassette, according to an embodiment;

FIG. 3B illustrates a cassette panel, according to an embodiment;

FIG. 3C schematically illustrates fiber connections of a shuffle cassette, according to an embodiment;

FIG. 3D illustrates an optical connection mating component of a shuffle cassette mated with a backplane mating connector of a tray, in according to an embodiment;

FIG. 4 shows a top perspective view of an example tray of a CPO shuffle-tray assembly, according to certain embodiments;

FIG. 5 shows a perspective view of an example CPO shuffle-tray assembly, according to certain embodiments;

FIG. 6A shows a front view of an example CPO shuffle-tray assembly, according to an example embodiment;

FIG. 6B shows a back view of the example CPO shuffle-tray assembly shown in FIG. 6A;

FIG. 6C shows a perspective view of the example CPO shuffle-tray assembly shown in FIG. 6A;

FIG. 7A shows a front view of another example CPO shuffle-tray assembly, according to an example embodiment;

FIG. 7B shows a back view of the example CPO shuffle-tray assembly shown in FIG. 7A;

FIG. 7C shows a perspective view of the example CPO shuffle-tray assembly shown in FIG. 7A.

FIG. 8 provides a front view of an example CPO shuffle-tray assembly installed within a rack of a datacenter, in accordance with certain embodiments;

FIG. 9 illustrates an example computer system that may include electrical components, according to at least one embodiment;

FIG. 10 provides a block diagram that schematically illustrates a computing system that may include one or more electrical components of various embodiments;

FIG. 11 illustrates an example computing environment that may include electrical components, in accordance with at least one embodiment;

FIG. 12 illustrates an example network switch according to at least one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

As computing resources and optical switch assemblies become more compact (e.g., due to CPO technologies), optical switch trays enable a higher density of optical connections. However, different customers have different needs for optical connections from a switch tray, leading to a need for flexibility in providing different connectivity layouts for optical switch trays.

As used herein, the term “optical cable” refers to a cable consisting of one or more optical fibers that are bundled together. The optical cable may provide the optic fibers in any geometric arrangement, including as a ribbon (e.g., with a plurality of optic fibers arranged side-by-side in one or more rows), as a grouped bundle that defines an at least substantially circular cross-section of the optical cable. In some embodiments, the individual fibers within a bundle may be individually sheathed (such that the sheaths of individual fibers are not connected with one another), and the plurality of sheathed fibers may be provided within a single jacket. In some embodiments, the jacket and sheath may be integrated, such as for a ribbon cable in which the integrated jacket and sheath serve to sheath individual fibers and to maintain a desired flat arrangement of the fibers relative to one another. The jacket and sheaths can be flexible, so that the resulting optical cable is flexible. As an example, the jacket and sheaths may be flexible polymers. However, it should be understood that other jacket and sheath configurations may be utilized.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light. In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally have a smaller diameter than the optical fibers. As such, a “world-to-chip” interface problem often arises in SiP technologies where coupling of light between Si wire waveguides and optical fibers, and vice versa, is generally inefficient.

“Co-packaging” may refer to the close integration of different electrical and/or optoelectronic chips in the same package.

In some embodiments, the shuffle box includes at least three connector types and at least two fiber types. One connector type connects to at least one of each of the other two connector types using different fiber types for each connection. Thus, a first connector type comprises at least two different fiber types (e.g., polarization maintaining fibers (PMFs) and single mode fibers (SMFs)). A first fiber type connects to a second connector type, and a second fiber type connects to a third connector type. SMFs comprises a single core surrounded by a cladding layer. PMF fibers comprise a single core having two stress rods on opposite sides of the core. The core and stress rods are surrounded by a cladding layer. As the terms are used herein, it should be understood that SMFs do not contain stress rods, while PMFs contain stress rods.

For a SiP-based shuffle box as a part of a CPO switch (or other optical I/O switch), the shuffle box accommodates over 1000 fibers (including both transmission and receiving fibers) without damaging them in order to provide optimal connections to multiple computing resources. Moreover, the shuffle box accommodates different types of fibers, such as SMF fibers for connection to the computing resources and PMF fibers for connection to external laser sources. The shuffle box is replaceable relative to an optical I/O switch, without damaging the included fibers.

### Example Shuffle Cassette

A shuffle cassette (also referred to as an optical connector box herein) as discussed herein is connectable with computing resources of an optical I/O switch (e.g., CPO computing resources operating as a CPO switchboard of a CPO switch) to connect an array of external connectors with multiple computing resources with both transmission and receiving fibers. In particular, a shuffle cassette is configured to connect with a subset of the I/O channels of the optical I/O switch. For example, a plurality of shuffle cassettes may be connected to the optical I/O switch such that the plurality of shuffle cassettes collectively provide external connectors coupled to the plurality of I/O channels of the optical I/O switch.

The shuffle cassette includes optical I/O connectors that connect with computing resources of the optical I/O switch, and the shuffle cassette acts as an adapter to connect a select external connector type (or multiple external connector types) with a subset of the I/O channels of the computing resources of the optical I/O switch. The shuffle cassette also accommodates multiple fiber types, including SMF and PMF fibers (more specifically, including transmission SMF, receiving SMF, and PMF fibers) for providing necessary connection types within the shuffle cassette. The shuffle cassette is replaceable, and can be detached from the optical I/O switch and replaced with an alternative configuration shuffle cassette, for example, with different external connector types. Each of the plurality of shuffle cassettes connected to an optical I/O switch may be independently detached from the optical I/O switch. Moreover, the same optical I/O switch assembly can be used with different shuffle cassette configurations as different customers may desire different connection options.

Computing resources (e.g., ASICs) are placed on individual, vertically stacked trays. The vertical shuffle cassette provides an efficient planarization of a large number of optical fibers (hundreds to thousands) emerging from multiple CPOs within the platform while achieving high manufacturing yield, ease of cleaning, and maintaining accessibility for debugging or maintenance. The shuffling is done inside the switch, making it more efficient and accessible. The cassettes are designed to primarily handle the vertical shuffling of optical fibers between the different trays in the stack, a direct consequence of the stacked ASIC architecture.

The stacked ASIC architecture (positioning the ASICs one above the other) supports vertical fiber routing (i.e. involving up and down shuffling) and allows ASICs to be pulled out like drawers for debugging and maintenance. The vertical shuffle cassette in which the connectors are placed to the left and right of the ASICs, provides a modular shuffling solution for quick assembly and integration of high fiber counts. The system's modular design allows for flexibility in the number of trays, accommodating different customer needs. For example, the system can be expanded to accommodate N trays (e.g. more than four trays), depending on the number of fibers in the connector, making it scalable and customizable. The system is designed as an assembly where both the trays (containing the ASICs) and the shuffle cassettes are independently removable and replaceable. Trays can be slid out from the rear of the assembly, and cassettes from the front, without needing to remove other components or the entire system from the rack. This improves serviceability, testing, and manufacturing efficiency.

The vertical shuffle cassette introduces a modular, scalable architecture which can combine slots for horizontal shuffling if needed, providing flexibility in the design. This allows for the creation of smaller cassettes that can replace the single monolithic shuffle box, making it easier to achieve reasonable yield during production and improve serviceability. The vertical shuffle cassette is independently testable and cleanable, reducing assembly errors. Single P/N cassette design enables vertical shuffling. Stacked ASICs support vertical shuffling while maintaining drawer-like for easy access. Each building block, such as a tray for the ASIC and the cassette, is independent which allows to split the monolithic shuffle into smaller shuffles by using the new mechanical architecture.

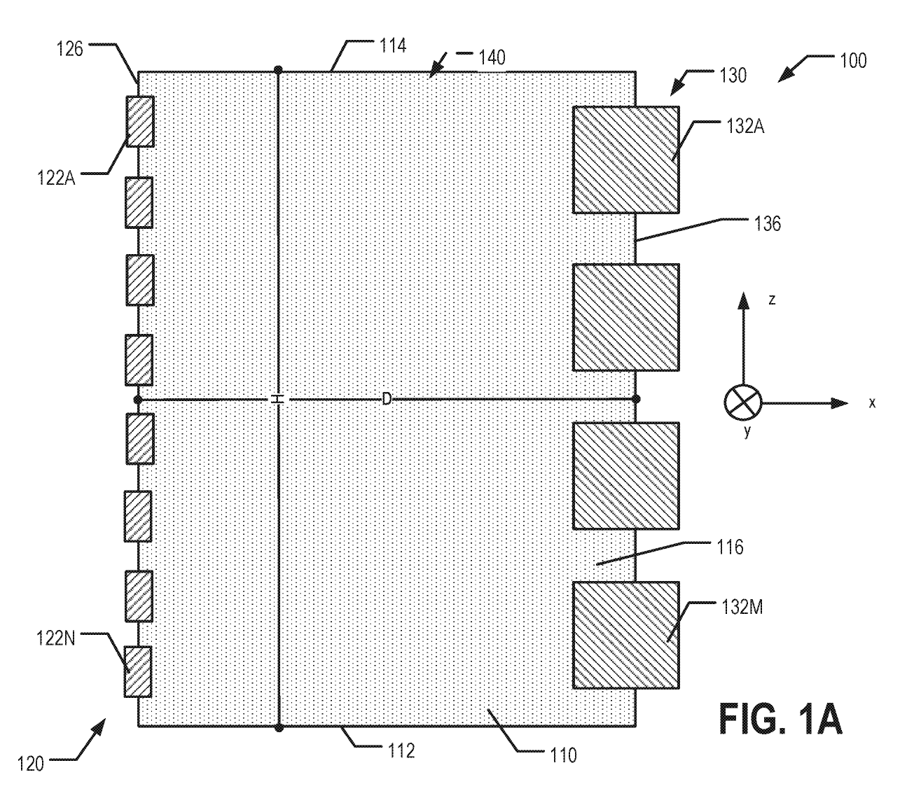

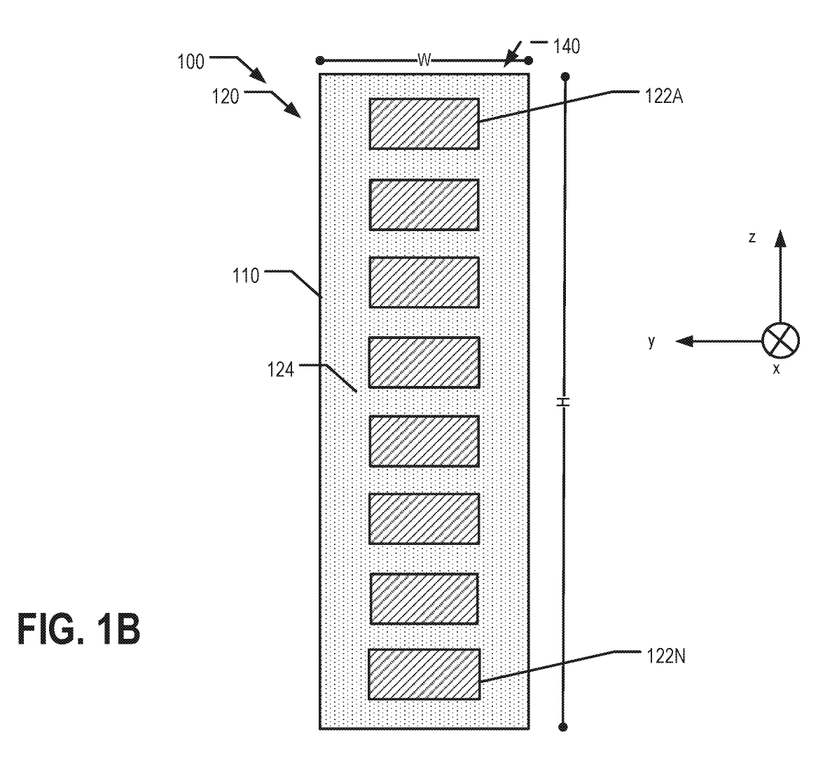

FIG. 1A illustrates a side view of an example shuffle cassette 100 and FIG. 1B illustrates a front view of the shuffle cassette 100, according to an example embodiment. The shuffle cassette 100 comprises a cassette housing 110 defining at least a front panel 126, a back panel 136, two side panels 116, a bottom surface 112, and a top surface 114. The two side panels 116, bottom surface 112, and top surface 114 each extend between respective edges of the front panel 126 and the back panel 136. The cassette housing 110 encloses a plurality of components (e.g., optical cables, optical connectors, and/or the like) connecting connectors disposed at the front panel 126 with connectors disposed at the back panel 136.

The shuffle cassette 100 includes a plurality of first optical connection mating components 120 disposed at the front panel 126 and a plurality of second optical connection mating components 130 disposed at the back panel 136. The optical connection mating components 122A-N of the plurality of first optical connection mating components 120 may include any of a variety of optical connectors such as multi-fiber push on (MPO) connectors, Lucent connectors (LC), Ferrule connectors (FC), multi-fiber connectors (MMC), SN connectors (by Senko Advance Components), and/or other optical connectors. The second optical connection mating components 132A-N of the plurality of second optical connection mating components 130 may include any of a variety of optical connectors such as MXC connectors, MMCs, LCs, FCs, SN connectors, and/or other optical connectors. An MXC connector is a compact, high-density fiber optic connector designed for data communications equipment like servers, routers, and switches. It uses an expanded beam technology with PRIZM MT ferrules that is less sensitive to debris and dirt compared to traditional physical contact connectors. In various embodiments, the optical connection mating components 132A-N of the plurality of second optical connection mating components 130 are optical backplane connectors arranged in a backplane array on the back panel 136 of the shuffle cassette 100. In various embodiments, optical connection mating components 132A-N of the plurality of second optical connection mating components 130 are blind mate connectors configured to be blind mated to corresponding optical backplane mating connectors of the one or more trays of a CPO shuffle-tray assembly. For example, the optical connection mating components 132A-N are configured to be mate-able with corresponding mating connectors without a user performing the mating having a line of sight of the optical connection mating components 132A-N and/or the optical backplane mating connectors during the coupling/mating of the optical connection mating components 132A-N to the optical backplane mating connectors.

In various embodiments, the plurality of second optical connection mating components 130 of a shuffle cassette 100 are arranged in one or more columns where the columns are arranged in a first direction (e.g., the z-direction as illustrated in FIGS. 1A and 1B). In various embodiments, the height H of the shuffle cassette in the first direction is configurable based on the number of trays to be coupled to the shuffle cassette. For example, a shuffle cassette 100 configured to be coupled to two trays may have a height H corresponding to 2U. A shuffle cassette 100 configured to be coupled to eight trays may have a height H corresponding to 8U. For example, an example shuffle cassette is configured to be coupled to four trays and has a height H corresponding to 4U where the height H is 175 mm. The number of trays to which a shuffle cassette 100 is configured to be coupled is determined based at least in part on the application and may vary from two to twenty or more.

In various embodiments, the shuffle cassette 100 has a depth D from the front panel 126 to the back panels 136 (e.g., in the x-direction as illustrated in FIGS. 1A and 1B). In certain embodiments, the depth D from the front panel 126 to the back panel 136 is less than 300 mm. For example, the depth D may be 200mm or less, in various embodiments.

In various embodiments, the shuffle cassette has a width W across the front panel 126 and/or across the back panel 136 (e.g., in the y-direction as illustrated in FIGS. 1A and 1B). In an example embodiment wherein the plurality of first optical connection mating components 120 and the plurality of second optical connection mating components 130 are each arranged in a respective single column aligned in the first direction, the width W is no more than 30 mm. For example, in an example embodiment wherein the plurality of first optical connection mating components 120 and the plurality of second optical connection mating components 130 are each arranged in a respective single column aligned in the first direction, the width W is 20 mm or less.

The cassette housing 110 defines volume 140 disposed between the front panel 126 and the back panel 136. For example, the volume 140 is defined on respective sides by the front panel 126, back panel 136, side panels 116, bottom surface 112, and top surface 114. In various embodiments, the shuffle cassette 100 includes a plurality of optical fibers disposed within the volume 140. The plurality optical fibers are configured to place a respective channel of a first optical connection mating component 122 (e.g., 122A-N) of the plurality of first optical connection mating components 120 into optical communication with a respective channel of a second optical connection mating component (e.g., 132A-M) of the plurality of second optical connection mating components 130.

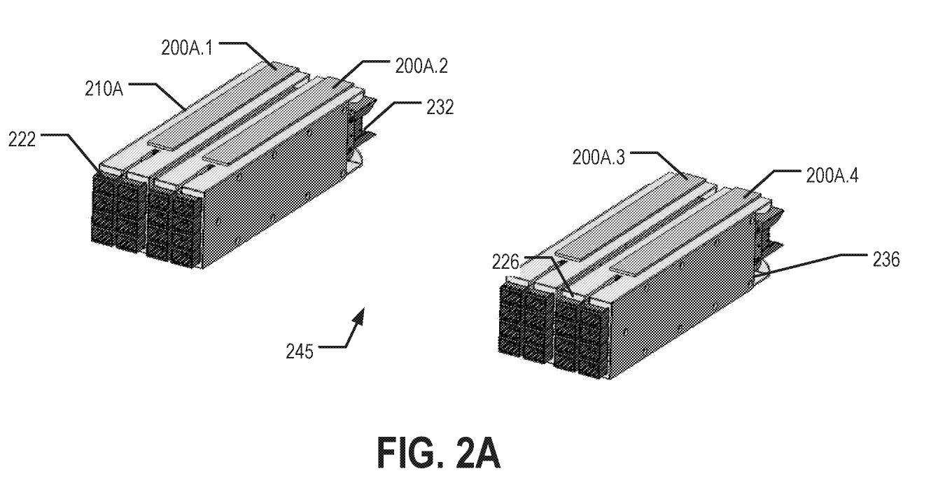

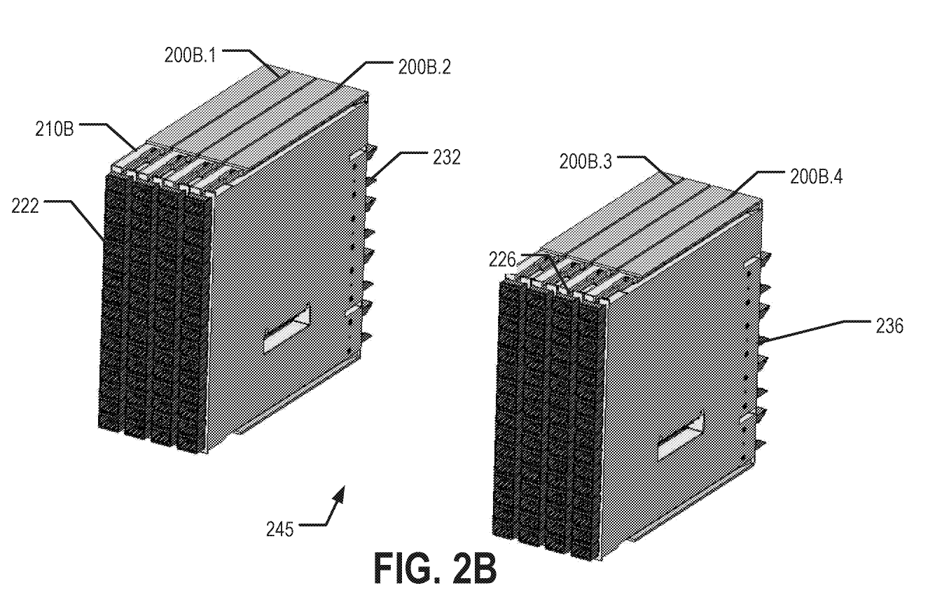

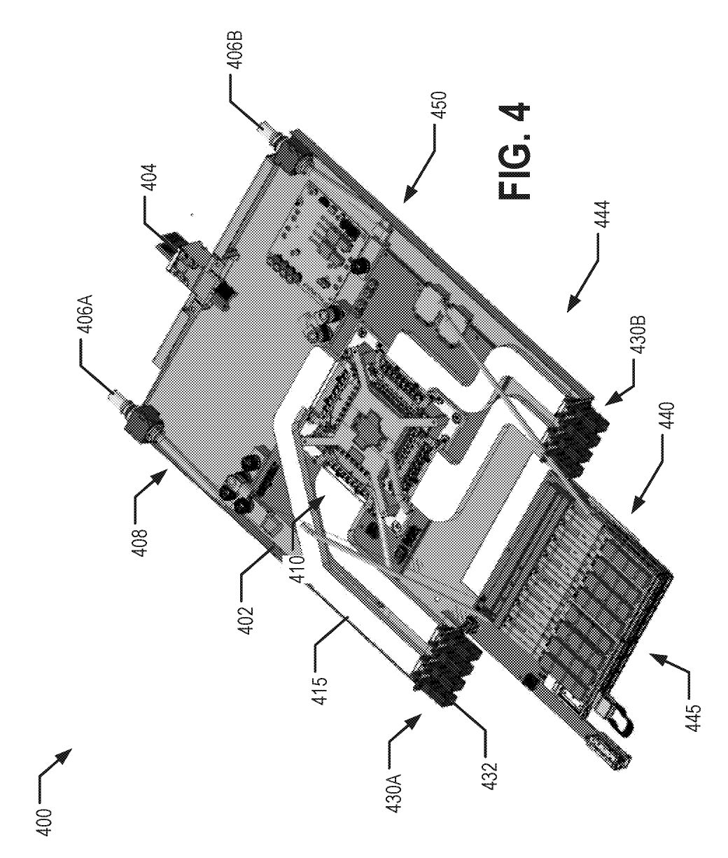

FIG. 2A illustrates a perspective view of a plurality of cassettes 200A.1-200A.4 configured to be coupled to a single tray and/or one ASIC. Each of the cassettes 200A includes a housing 210A having a front panel 226 and a back panel 236. The front panels 226 of the cassettes 200A each have a plurality of first optical connection mating components 222 disposed thereon. The back panels 236 of the cassettes 200A each have a second optical connection mating component 232 disposed thereat. The cassettes 200A are positioned with a user interface gap 245 disposed between two sets of cassettes. The user interface gap 245 is configured such that an extension portion 440 hosting a user interface 445 of a tray 400 may extend therethrough (see FIG. 4).

FIG. 2B illustrates a perspective view of a plurality of cassettes 200B.1-200B.4 configured to be coupled to a plurality (e.g., a stack) of trays and/or ASICs. Each of the cassettes 200B includes a housing 210B having a front panel 226 and a back panel 236. The front panels 226 of the cassettes 200A each have a plurality of first optical connection mating components 222 disposed thereon. The back panels 236 of the cassettes 200B each have a plurality (e.g., a column) of second optical connection mating components 232 disposed thereat. The cassettes 200B are positioned with a user interface gap 245 disposed between two sets of cassettes. The user interface gap 245 is configured such that an extension portion 440 hosting a user interface 445 of a tray 400 may extend therethrough.

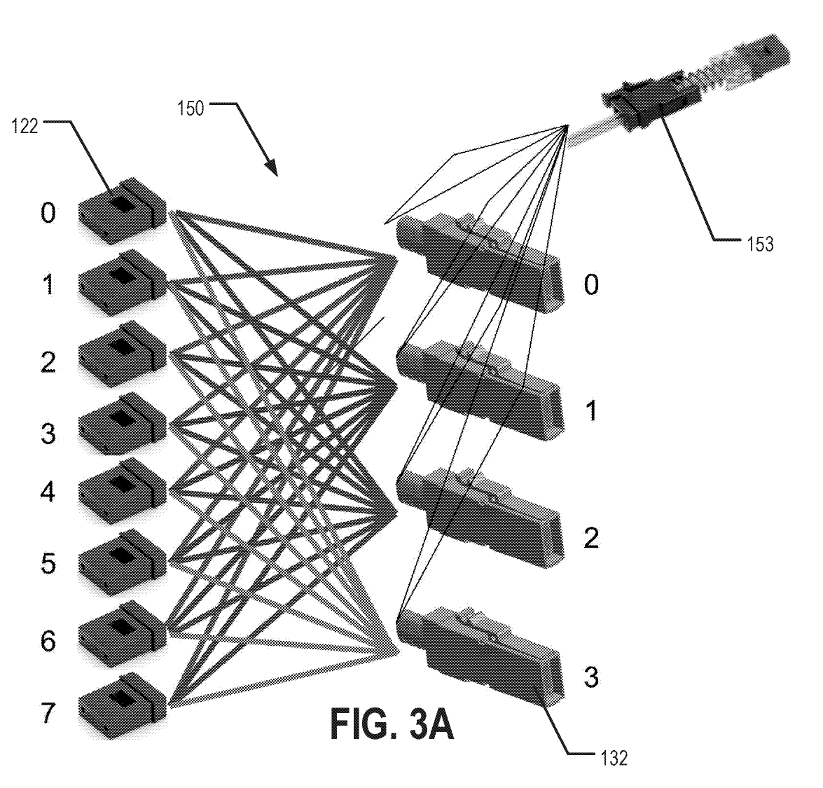

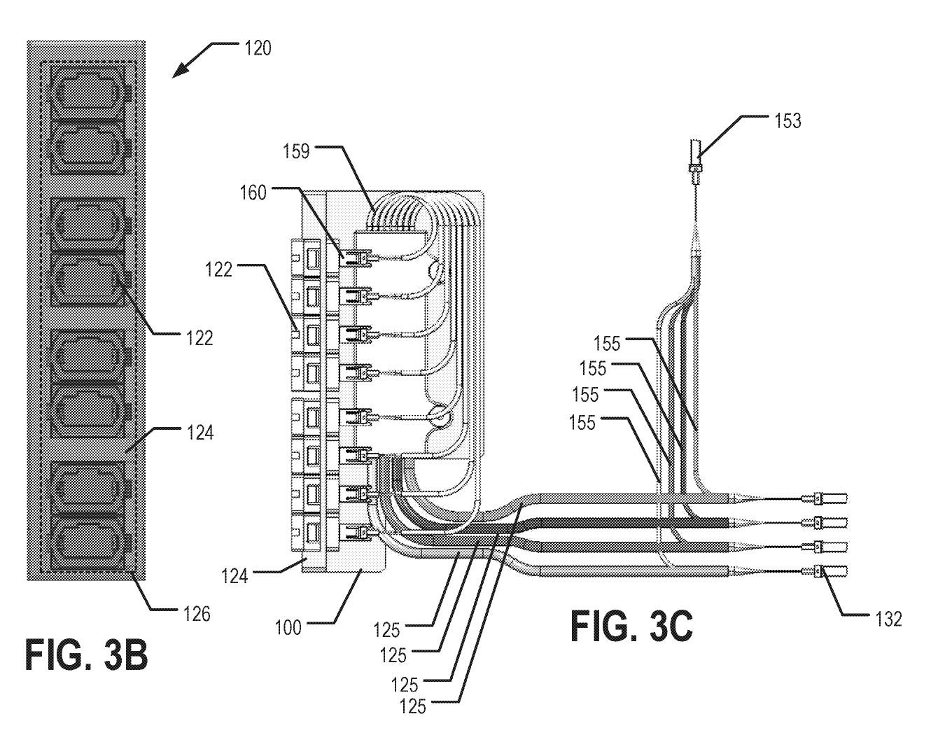

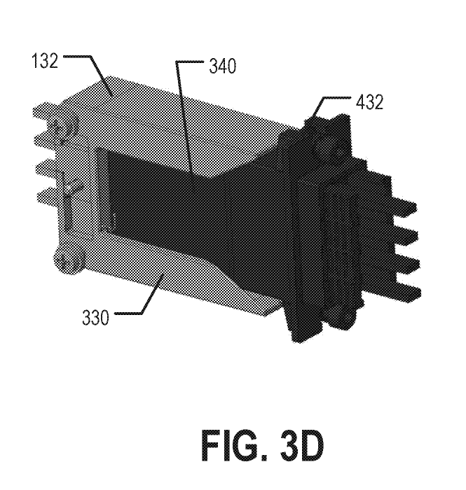

A plurality optical fibers disposed within a cassette 200A, 200B are configured to place respective channels of the first optical connection mating components 222 into optical communication with respective channels of second optical connection mating components 232. For example, FIGS. 3A and 3C illustrate a plurality of optical connections 150 provided via optical fibers, for example. FIG. 3B provides a front view of an example shuffle cassette 100.

In certain embodiments, the plurality of optical fibers include optical fibers configured to couple external lasers to respective inputs of one or more trays and/or CPO switch of a CPO shuffle-tray assembly. For example, some of the optical fibers may include external laser small form factor pluggable (ELSFP) connectors 153. Optical cables 155 for the ELSFP connectors 153 can be routed out of the cassette housing 110 through the back panel 136, through a ELSFP cable housing (which may be secured to the cassette housing 110 by a bracket, for example), and out ELSFP apertures within the back panel 136 that are aligned with the ELSFP connectors 153. As a result, the ELSFP connectors 153 (and their respective housings) are in optical communication with the second optical connection mating components 132A-M, such that ELSFP sources can be plugged into the ELSFP connectors through respective connectors disposed on an access panel of an assembly housing configured to house a CPO shuffle-tray assembly including the shuffle cassette 100.

FIG. 3B shows a front panel 126 of the shuffle cassette 100. As shown, the first optical connection mating components 122 are defined as female connectors in the illustrated embodiments. In the illustrated embodiment, a connection points subset is 8 connection points (arranged vertically in the illustrated embodiment).

Each of the first optical connection mating components 122 on the front panel 126 are connected with multiple second optical connection mating components 132 on a back panel 136 of the shuffle cassette 100 by a plurality of optical fibers. When the shuffle cassette 100 is provided as a part of an optical I/O switch, each first optical connection mating component 122 is connected with a plurality of computing resources (e.g., ASICs) of the optical I/O switch by optical fibers that extend from each first optical connection mating component 122 to a plurality of second optical connection mating components 132 arranged in a backplane array on a back panel 136 of the shuffle cassette 100. The high-density optical fiber shuffling cassette may be used for stacked ASIC architecture. For example, it may comprise 3D-stacked electronic and photonic ICs. 3D stacked electronic and photonic IC refers to a type of integrated circuit (IC) where electronic (electrical) and photonic (optical) components are vertically integrated (stacked) in multiple layers to enhance performance, reduce footprint, and enable new functionality—especially in high-speed communication, AI, and data center applications. 3D stacking involves placing multiple chips or functional layers (tiers) on top of each other using through-silicon vias (TSVs), micro-bumps, interposers, or hybrid bonding. In the case of electronic-photonic integration, the goal is to combine fast electrical processing with optical data transmission or processing, enabling: higher bandwidth density, lower power consumption per bit, reduced latency in data movement, improved thermal management.

In some embodiments, the second optical connection mating components 132 are positioned within connector housings that serve to guide the second optical connection mating components 132 into connection with optical backplane mating connectors 432 of trays (hosting computing resources such as ASICs and/or the like) of a CPO shuffle-tray assembly (e.g., an optical I/O switch) as the shuffle cassette 100 is slid into position within the CPO shuffle-tray assembly. For example, the connector housings may be configured to enable blind mating of the second optical connection mating components 132 of the shuffle cassette 100 with the optical backplane mating connectors 432 of trays of the CPO shuffle-tray assembly.

The second optical connection mating components 132 (and their respective housings) occupy a substantial amount of space on the back panel 136. In some embodiments, the second optical connection mating components 132 and their respective housings collectively occupy greater than 25% of the total area of the back panel 136. More specifically, the second optical connection mating components 132 and their respective housings collectively occupy greater than 30% of the total area of the back panel 136.

In the illustrated embodiments, the second optical connection mating components 132 are MXC connectors that are provided to connect with optical backplane mating connectors 432 of the trays 400 that host the computing resources of the optical I/O switch. However, other optical connector types may be used. Each of the second optical connection mating components 132 are connected to a plurality of first optical connection mating components 122 on the front panel 126 by a plurality of optical fibers. Because each second optical connection mating components 132 connects with a mating connector on the tray 400 that connects with a single computing resource, optical fibers in the shuffle cassette 100 serve to connect each of the first optical connection mating components 122 with all of the computing resources of the optical I/O switch through the plurality of second optical connection mating components 132 on the back panel 136. Each second optical connection mating components 132 in the back panel 136 may extend through an aperture of the back panel 136 configured to accommodate a single second optical connection mating components 132 (and housing). In other embodiments, the second optical connection mating components 132 may be arranged into subsets of connectors that are secured relative to one another in the shuffle cassette and the apertures in the back panel 136 may be configured to accommodate all connectors of the shuffle cassette that are connected to one another.

FIG. 3A provides further granularity of the shuffling among the plurality of first optical connection mating components 122 of a shuffle cassette 100 with the plurality of second optical connection mating components 132. As shown, each of the first optical connection mating components 122 of a shuffle cassette 100 (shown as a multi-fiber connector) is disposed within a cassette panel 124 (shown in close-up in FIG. 3B) and is optically connected with all of the second optical connection mating components 132 for the shuffle cassette 100. For example, each first optical connection mating component 122 is connected to every second optical connection mating components 132 of the shuffle cassette 100 by a plurality of optical fibers (e.g., 2 optical fibers in a simplex regime that collectively defines a lane including one fiber for transmission and one fiber for receipt).

FIG. 3C illustrates the connections between the first optical connection mating components 122 of a shuffle cassette 100 and the second optical connection mating components 132 and ELSFP connector 153. As shown, optical fibers may be contained in one or more optical cables (e.g., optical cables 125, 159) and may connect to the first optical connection mating components 122 using at least one connector 160. Moreover, all of the plurality of second optical connection mating components 132 are connected with one ELSFP connector 153 and an optical cable 155 extends from each ELSFP connector 153 and into the shuffle cassette 100 where it is connected with the second optical connection mating components 132.

In practice, shuffling among first optical connection mating components 122 of a single shuffle cassette 100 provides a first layer of shuffling of signals (which may be referred to as vertical shuffling or vertical shuffle cassette, with reference to the connection points being arranged in a vertical column within a cassette while the fibers are distributed horizontally). This configuration allows for the distribution of a high number of fibers into smaller, manageable groups, thereby improving both manufacturing yield and ease of maintenance.

FIG. 3D illustrates a second optical mating component 132 of an example embodiment mated with an optical backplane mating connector 432. In various embodiments, the second optical mating component 132 and the optical backplane mating connector 432 are configured to be blind mated with one another. For example, the second optical mating component 132 includes channeled arms 330 configured to receive an elongated coupling portion 430 of an optical backplane mating connector 432 therein. Channels defined in the channeled arms 330 guide the elongated coupling portion 430 into a mated position such that the second optical mating component 132 and the optical backplane mating connector 432 are optically coupled to one another.

### Example Tray

FIG. 4 illustrates and example tray 400 of a CPO shuffle-tray assembly. For example, the tray 400 may be a CPO switch tray that hosts a computing resources 410. For example, the computing resource 410 may be an ASIC or other processing and/or data management circuitry. It should be understood that the tray 400 illustrated in FIG. 4 is just one example of an optical I/O switch according to certain embodiments.

The tray 400 comprises at least one computing resource 410 mounted on a substrate 402. A plurality of optical fibers (which may be bundled in cables 415) are connected with the computing resource 410. The optical fibers are routed across a portion of the tray 400 to optical backplane mating connectors 432. The optical backplane mating connectors 432 are configured to connect second optical connection mating components 132 of the shuffle cassette 100 such that the second optical connection mating components 132 are mechanically coupled to the tray 400 and optically coupled to the computing resources 410.

The tray 400 houses the above-mentioned components within a tray housing 450. The tray housing 450 comprises one or more mating installation components that interact with the support components of an assembly housing configured to house the CPO shuffle-tray assembly. The support components may comprise one or more horizontal staging supports that supports the weight of the tray 400 when the horizontal staging ledges of the tray are resting on corresponding the staging supports of the assembly housing of the CPO shuffle-tray assembly. For example, the horizontal staging supports may be configured to enable the tray 400 to be slid into and our out of place within the CPO shuffle-tray assembly.

In various embodiments a tray 400 comprises a busbar connector 404 configure to be placed into electrical communication with a busbar of a rack hosting the CPO shuffle-tray assembly. For example, the tray 400 may be configured to receive (DC) electrical power via the busbar connector 404.

In various embodiments, a tray 400 comprises a cooling sub-system 408. In various embodiments, the cooling sub-system 408 is configured to cool the computing resource 410 and/or other tray components hosted by the tray 400. In various embodiments, the cooling sub-system 408 includes liquid cooling ports 406A, 406B configured to be coupled to respective liquid cooling manifolds of a rack hosting the CPO shuffle-tray assembly. In some embodiments, the cooling sub-system 408 may additionally or alternatively include components configured to air cool the computing resource 410 hosted by the tray 400.

In the illustrated embodiment, the tray 400 includes two sets 430A, 430B of optical backplane mating connectors 434. The tray 400 includes an extension portion 440 that extends from a resource-hosting portion 444 of the tray 400. In the illustrated embodiment, the extension portion 440 extends between the two sets 430A, 430B of optical backplane mating connectors 432. In various embodiments, the extension portion 440 hosts a user interface 445. For example, the user interface 445 may include one or more indicator lights (e.g., indicator light emitting diodes (LEDs)) that may be configured to provide an observer with information regarding a status of the tray 400 and/or the computing resource 410 hosted by the tray.

### Example CPO Shuffle-Tray Assembly

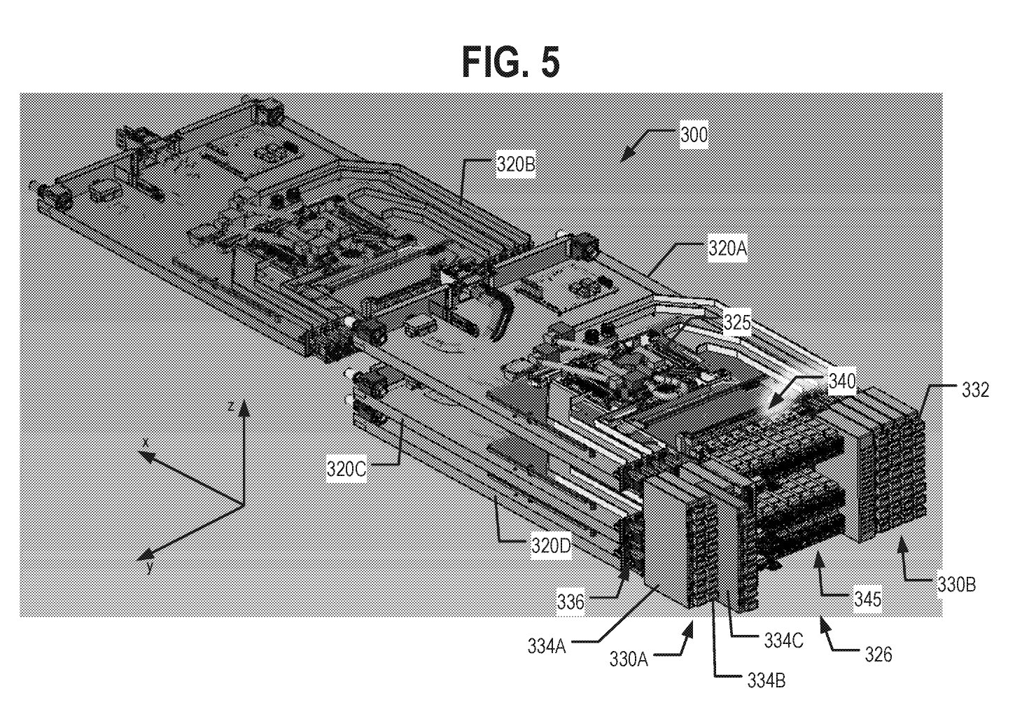

In various embodiments, a CPO shuffle-tray assembly may be an optical I/O switch or other computing system/sub-system or datacenter component configured for optical I/O. FIG. 5 illustrates an example CPO shuffle-tray assembly 300. The CPO shuffle-tray assembly 300 includes one or more trays 320 (e.g., 320A-D) that host respective computing resources 325 (e.g., an ASIC, switch, processing unit, and/or the like) and/or other elements of the CPO shuffle-tray assembly.

Each of the trays comprises a plurality of optical backplane mating connectors 336. The optical backplane mating connectors 336 of the trays 320 are arranged so as to form columns of optical backplane mating connectors in the first direction. For example, each column may include an optical backplane mating connector 336 of each tray 320 of the CPO shuffle-tray assembly 300.

The CPO shuffle-tray assembly 300 further comprises a plurality of shuffle cassettes 334 (e.g., 334A, 334B, 334C). Each shuffle cassette is configured to be coupled (e.g., via the plurality of second optical connection mating components 130 disposed at the back panel 136 of the shuffle cassette) to (a sub-set of) the optical backplane mating connectors 336 of multiple trays 320 of the CPO shuffle-tray assembly 300. The shuffle cassettes 334 are configured to be coupled to the optical backplane mating connectors 336 of the trays such that the first optical connection mating components 332 of the shuffle cassettes are exposed or available for interaction therewith (e.g., via an access panel 326 of the CPO shuffle-tray assembly) while the shuffle cassettes 334 are coupled to the trays 320.

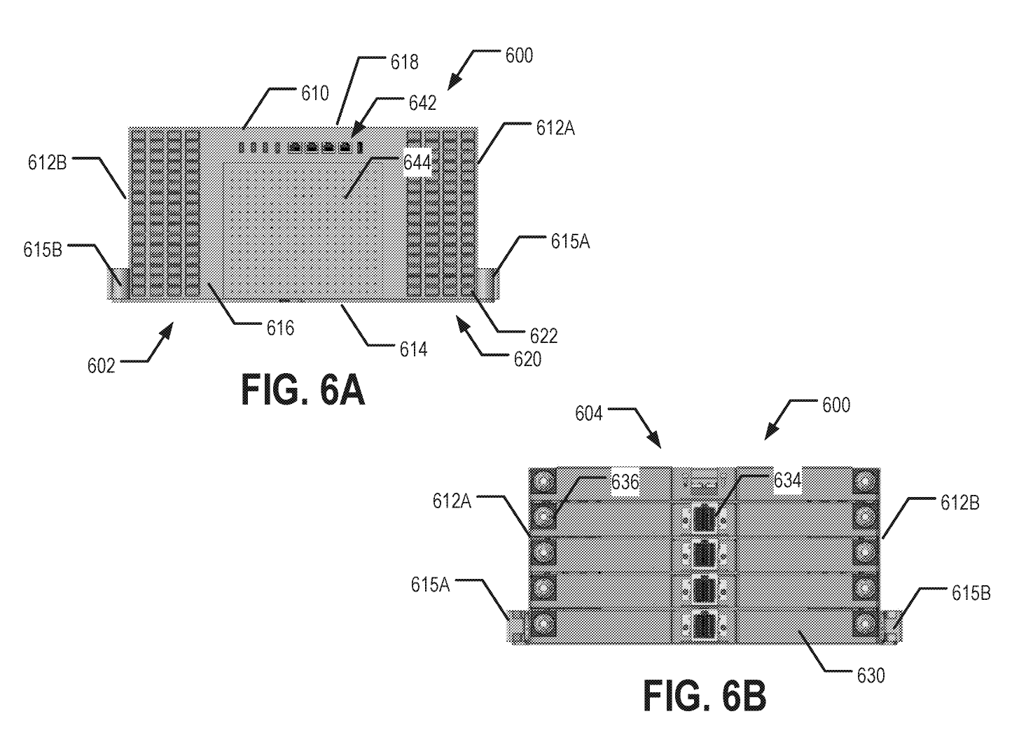

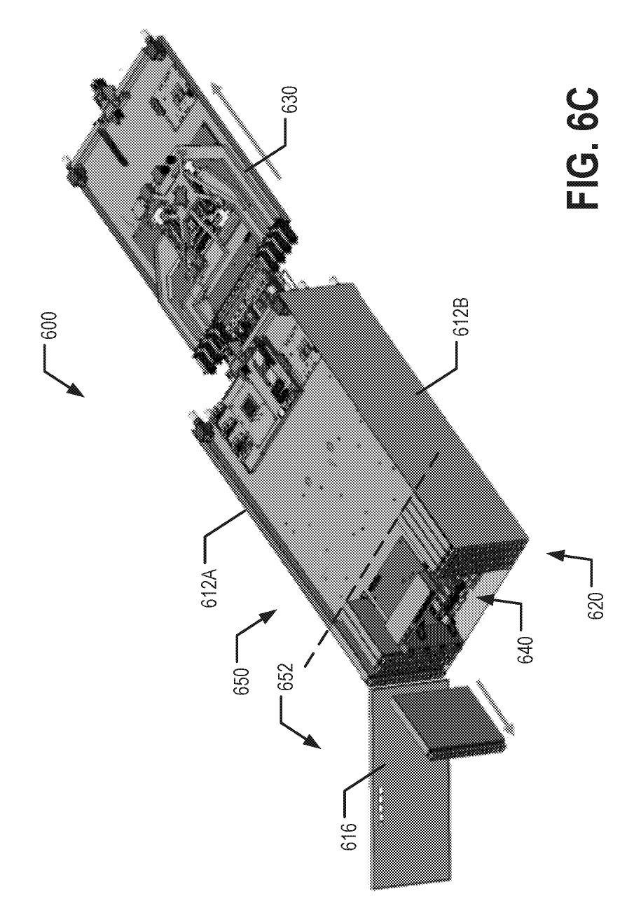

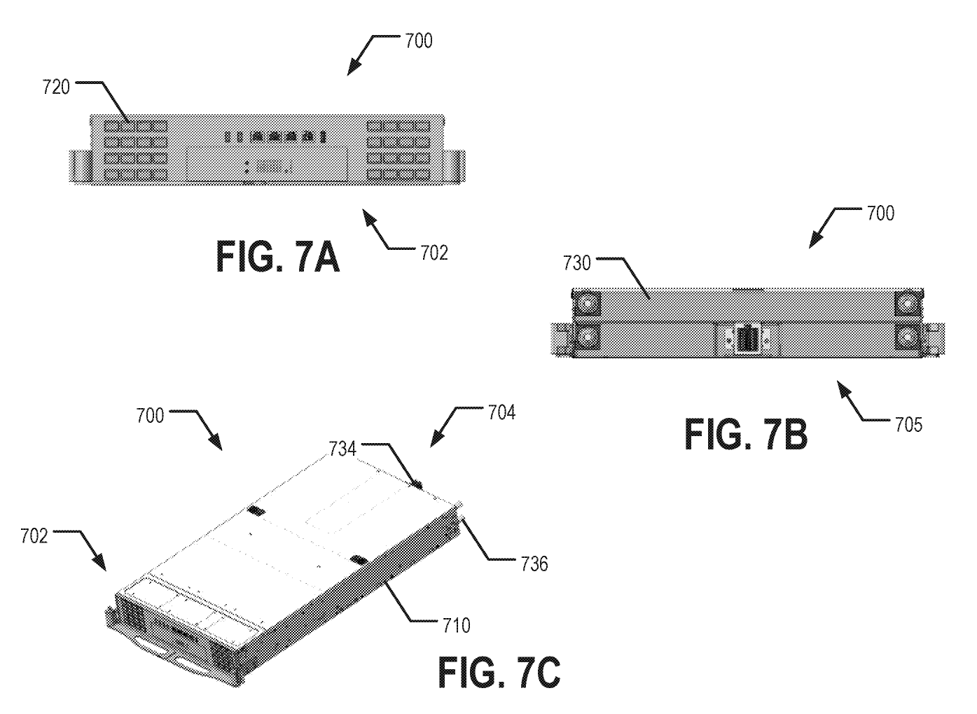

In various embodiments, the shuffle cassettes 334 are configured to place respective computing resources 325 of the trays 320 into optical communication with the plurality of first optical connection mating components 332. In various embodiments, the trays 320 are configured to be aligned with one another in tray column in a first direction and the shuffle cassettes 334 are aligned with the tray column in a second direction that is perpendicular to the first direction. For example, the trays 320 are aligned in a tray column that extends in the first direction (e.g., z-direction as shown in FIG. 5) and the shuffle cassettes are aligned in a cassette row in a second direction (e.g., the y-direction as shown in FIG. 5). In certain embodiments, the trays 320 are configured to be aligned with one another in a tray column in a first direction such that the optical backplane mating connectors 336 of the one or more trays 320 are arranged into columns of optical backplane mating connectors that are aligned in the first direction (e.g., the z-direction as illustrated in FIG. 5). The plurality of second optical connection mating components 130 of the shuffle cassettes 334 are arranged in one or more columns of optical connection mating components with the one or more columns oriented in the first direction. Thus, the plurality of second optical connection mating components 130 of the shuffle cassettes 334 are arranged to couple onto the one or more columns of optical backplane mating connectors. For example, in certain embodiments, each shuffle cassette 334 couples a respective single column of optical backplane mating connectors 336 (e.g., see FIGS. 6A-6C). In some embodiments, each shuffle cassette 334 couples onto a respective two columns of optical backplane mating connectors 336 (e.g., see FIGS. 7A-7C).

In the illustrated embodiment, the optical backplane mating connectors 336 are provided in two subsets with the extending portions 340 of the respective trays 320 extending out from the resource-hosting portion of the respective tray between the two subsets of optical backplane mating connectors 336. For example, the user interface 345 provided by the extending portions 340 of the respective trays 320 may be configured to be disposed between two groups 330A, 330B of shuffle cassettes 334.

In various embodiments, each tray 320 is configured to be electrically, optically, and mechanically independent of any other trays of the CPO shuffle-tray assembly 300. For example, FIG. 5 illustrates a tray 320B being slid out of the CPO shuffle-tray assembly 300. As the tray 320B has no electrical, optical, or mechanical connections to the other trays of the CPO shuffle-tray assembly 300, the tray 320B can be slid out of the CPO shuffle-tray assembly 300 without affecting any other trays of the CPO shuffle-tray assembly 300. By sliding the tray 320B out of the CPO shuffle-tray assembly 300, the optical backplane mating connectors 336 of the tray 320B are decoupled from the shuffle cassettes 334. No other disconnections are required to remove the tray 320B from the CPO shuffle-tray assembly 300. In other words, the trays 320 are only connected to other trays 320 of the CPO shuffle-tray assembly 300 and to the shuffle cassettes 334 of the CPO shuffle-tray assembly 300 via the coupling of the optical backplane mating connectors 336 to respective second optical connection mating components 132 of respective shuffle cassettes 334.

FIG. 5 illustrates a shuffle cassette 334C being slid out of the CPO shuffle-tray assembly 300. As the shuffle cassette 334C has no electrical, optical, or mechanical connections to the other shuffle cassettes of the CPO shuffle-tray assembly 300, the shuffle cassette 334C can be slid out of the CPO shuffle-tray assembly 300 without affecting any other shuffle cassettes of the CPO shuffle-tray assembly 300. By sliding the shuffle cassette 334C out of the CPO shuffle-tray assembly 300, the plurality of second optical connection mating components 130 of the shuffle cassette 334C are decoupled from the optical backplane mating connectors 336 of the trays 320. No other disconnections are required to remove the shuffle cassette 334C from the CPO shuffle-tray assembly 300. In other words, the shuffle cassette 334C is independent of the other shuffle cassettes and are only connected to the trays 320 of the CPO shuffle-tray assembly 300 of the CPO shuffle-tray assembly 300 via the coupling of the second optical connection mating components 132 to respective optical backplane mating connectors 336 of respective trays 320.

For example, the shuffle cassettes 334 may be individually removed from the CPO shuffle-tray assembly 300 for cleaning, servicing, and/or replacement with another shuffle cassette (possibly having a different connectivity topology, a different type of first optical connection mating components, and/or a different type of second optical connection mating components). A shuffle cassette 334 may be individually installed into the CPO shuffle-tray assembly 300. In another example, the trays 320 may be individually removed CPO shuffle-tray assembly 300 for cleaning, servicing, and/or replacement with another tray (e.g., possibly having a different computing resource, a different type of optical backplane mating connectors, and/or the like). A tray 320 may be individually installed into the CPO shuffle-tray assembly 300.

FIGS. 6A, 6B, and 6C illustrate an example CPO shuffle-tray assembly 600 comprising an assembly housing 610, a plurality of trays 630, and a plurality of shuffle cassettes 620. The assembly housing 610 includes a first sidewall 612A, a second sidewall 612B, and a floor component 614 mechanically coupled to the first sidewall 612A and the second sidewall 612B. The first sidewall 612A, second sidewall 612B, and floor component 614 define an interior of the assembly housing. The assembly housing 610 may further includes an access panel 616 and possibly a top component 618. In various embodiments, the access panel 616 is configured to face forward and/or to the front of a rack when the CPO shuffle-tray assembly 600 is mounted in a rack so as to provide access to the front panels 126 of one or more shuffle cassettes of the CPO shuffle-tray assembly and a user interface of one or more trays of the CPO shuffle-tray assembly.

The assembly housing 610 may be open in the back such that the busbar connectors 634 of the trays 630 of the CPO shuffle-tray assembly 600 extend out from the interior of the assembly housing. For example, the busbar connectors 634 extend out from the back 604 of the assembly housing 610. For example, the busbar connectors 634 may extend out from the interior of the assembly housing such that they may be coupled to a busbar. In various embodiments, the trays 630 include cooling ports 636. The assembly housing 610 is further configured to enable access to the cooling ports 636 of the trays 630 via a back of the assembly housing 610.

In various embodiments, the CPO shuffle-tray assembly 600 is configured to be positioned within a rack. For example, the first sidewall 612A and the second sidewall 612B may include support ledges 615A, 615B configured to slide into respective rack supports. For example, sliding the support ledges 615A, 615B into respective rack supports may be cause the busbar connectors 634 of the trays 630 of the CPO shuffle-tray assembly 600 to be coupled into electrical communication with a busbar of the rack and/or cause liquid cooling ports 636 of the trays 630 of the CPO shuffle-tray assembly 600 to be coupled into fluid communication with liquid cooling manifolds of the rack.

In various embodiments, an interior of the assembly housing 610 may be thought of as being divided into first portion 650 and a second portion 652. The trays 630 are stacked in the first portion 650 and the shuffle cassettes are disposed in the second portion 652 of the assembly housing 610. In various embodiments, the trays 630 comprise respective extension portions 640 that extend into the second portion 652 of the interior of the assembly housing 610.

The access panel 616 of the assembly housing 610 provides user access to a user interface hosted by the extension portions 640 of the trays 630. For example, the access panel 616 may include network (e.g., ethernet), universal serial bus (USB) and/or other electrical connectors 642 in electrical communication with one or more trays of the CPO shuffle-tray assembly. The access panel 616 may also provide access windows 644 that enable an observer to observe the indicator lights of the user interface.

The front 602 of the assembly housing 610 further provides access to the first optical connection mating components 622 of the shuffle cassettes 620 of the CPO shuffle-tray assembly 600. The access panel 616 of the assembly housing 610 further comprises one or more openings that are configured to permit access to the first optical connection mating components 622 of the shuffle cassettes 620 of the CPO shuffle-tray assembly 600 therethrough. In some embodiments, the access panel 616 is in a fixed mechanical relationship with the first sidewall 612A, second sidewall 612B, and the floor component 614 of the assembly housing 610. In some embodiments, the access panel 616 is in a hinged relationship with one of the first sidewall 612A or the second sidewall 612B, as shown in FIG. 6C.

As shown in FIG. 6C, a shuffle cassette 620 may be removed from the CPO shuffle-tray assembly 600 via an access opening in the access panel 616 or by moving the access panel (e.g., via a hinged connection to a sidewall 612 of the assembly housing) to permit access to the shuffle cassette 620. For example, the assembly housing 610, shuffle cassettes 620, and trays 630 of the CPO shuffle-tray assembly 600 are configured such that each shuffle cassette 620 of the plurality of shuffle cassettes is removable from the assembly housing without removing any of the one or more trays 630 and without removing any other shuffle cassettes from the assembly housing 610 and without un-mating the second optical connection mating component-optical backplane mating connector connections of any other of the shuffle cassettes.

A tray 630 may be removed from the CPO shuffle-tray assembly 600 via the open back of the assembly housing 610. For example, For example, the assembly housing 610, shuffle cassettes 620, and trays 630 of the CPO shuffle-tray assembly 600 are configured such that each tray 630 of the of the one or more trays of the CPO shuffle-tray assembly 600 is removable from the assembly housing 610 without removing any other of the one or more trays 630 and without removing any of shuffle cassettes 620 from the assembly housing 610 and without un-mating the second optical connection mating component-optical backplane mating connector connections of any other of the one or more trays.

FIGS. 7A, 7B and 7C, illustrate another CPO shuffle-tray assembly 700 comprising an assembly housing 710 that provides access to first optical connector components of a plurality of cassettes 720 via a front 702 of the assembly housing 710. The assembly housing 710 is open in the back 704 to enable the busbar connectors 734 and liquid cooling ports 736 of the trays 730 of the CPO shuffle-tray assembly 700 to extend out therefrom (e.g., for coupling to a busbar) and to enable trays 730 to be removed from the assembly housing 710.

The CPO shuffle-tray assembly 600 is configured to include five trays. Four of the trays 730 host computing resources and are electrically powered via respective busbar connectors 634 and a passive tray (e.g., that does not include a busbar connector) and that hosts passive components of the CPO shuffle-tray assembly 600. The CPO shuffle-tray assembly 700 is configured to include two trays. One of the trays 730 hosts a computing resource and is electrically powered via the busbar connectors 734 and a passive tray (e.g., that does not include a busbar connector) and that hosts passive components of the CPO shuffle-tray assembly 700. In an example embodiment, both the CPO shuffle-tray assembly 600 and the CPO shuffle-tray assembly 700 include eight shuffle cassettes each comprising a plurality of first optical connection mating components arranged in a single column and a plurality of second optical connection mating components arranged in a single column. In certain embodiments, the CPO shuffle-tray assembly 600 and/or the CPO shuffle-tray assembly 700 include four shuffle cassettes each comprising a plurality of first optical connection mating components arranged in two columns and a plurality of second optical connection mating components arranged in two columns.

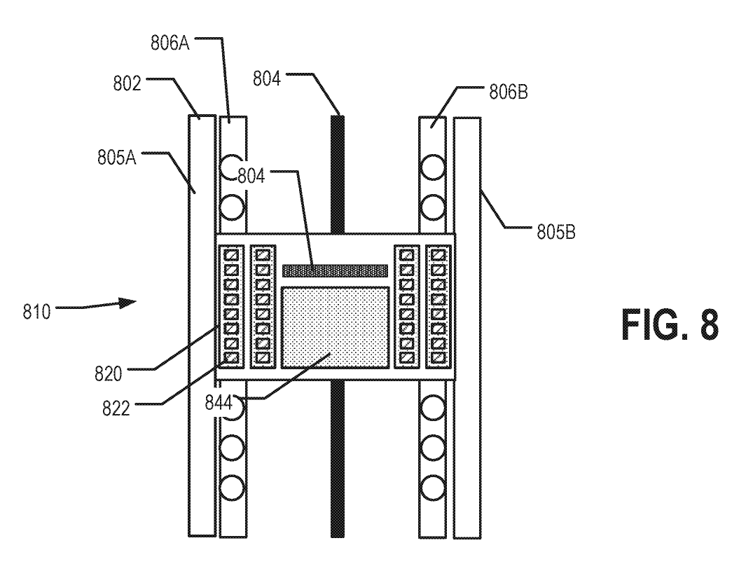

FIG. 8 provides a front view of an example CPO shuffle-tray assembly 810 installed in a rack 802. The rack comprises a plurality of rails 805 (e.g., 805A, 805B) configured to provide structural support for mounting a CPO shuffle-tray assembly 810. The rack 802 further includes liquid cooling manifolds 806 configured to have liquid cooling ports of trays of a CPO shuffle-tray assembly 810 to be coupled thereto. The rack 802 further includes a busbar 804 configured to provide electrical power to one or more trays of a CPO shuffle-tray assembly 810 via respective busbar connectors.

Via the front of the rack 802, the first optical connection mating components 822 of the plurality of shuffle cassettes of the CPO shuffle-tray assembly 810 are accessible. Indicator lights 844 configured to provide indication of the status respective trays are observable from the front of the rack 802. Network (e.g., ethernet), universal serial bus (USB) and/or other electrical connectors 642 of the CPO shuffle-tray assembly 810 may also be available via the front of the rack 802.

### Example Systems Including CPO Shuffle-Tray Assemblies

In various embodiments, CPO shuffle-tray assemblies may be CPO switches, other optical I/O switches, processing units, ICs, systems on and/or including PCBs, optical interconnects, and/or the like. In various embodiments, a datacenter may include one or more CPO shuffle-tray assemblies. CPO shuffle-tray assemblies and systems including CPO shuffle-tray assemblies of various embodiments are now described.

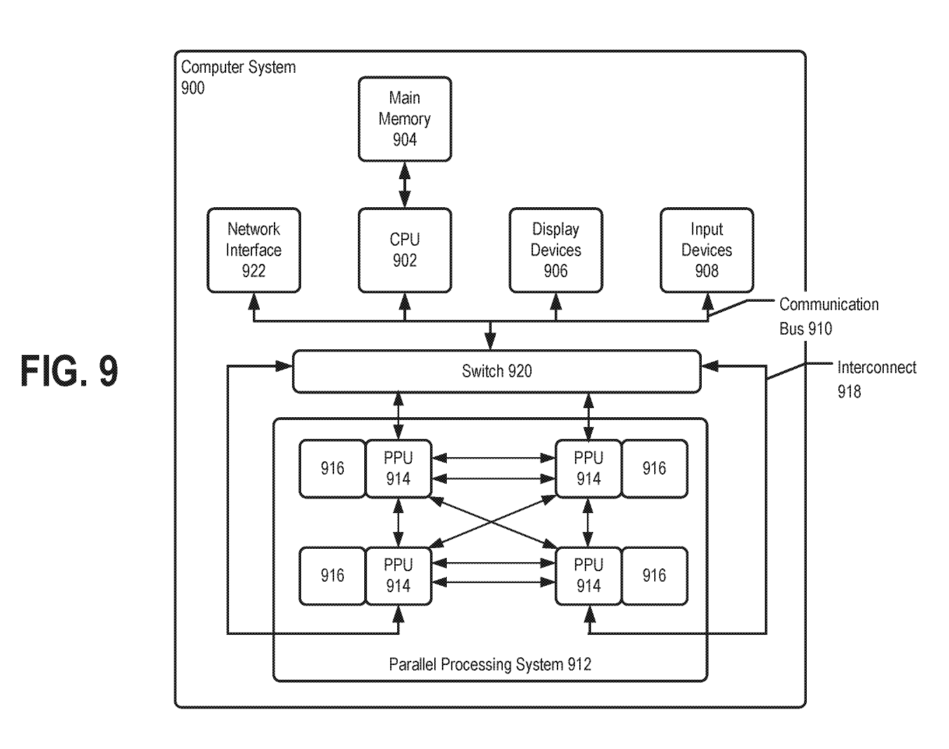

FIG. 9 illustrates a computer system 900, according to at least one embodiment. In at least one embodiment, computer system 900 is configured to implement various processes and methods described throughout this disclosure.

In at least one embodiment, computer system 900 comprises, without limitation, at least one central processing unit (“CPU”) 902 that is connected to a communication bus 910 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 900 includes, without limitation, a main memory 904 and control logic (e.g., implemented as hardware, software, or a combination thereof) and data are stored in main memory 904 which may take form of random access memory (“RAM”). In at least one embodiment, a network interface subsystem (“network interface”) 922 provides an interface to other computing devices and networks for receiving data from and transmitting data to other systems from computer system 900.

In at least one embodiment, computer system 900, in at least one embodiment, includes, without limitation, input devices 908, parallel processing system 912, and display devices 906 which can be implemented using a conventional cathode ray tube (“CRT”), liquid crystal display (“LCD”), light emitting diode (“LED”), plasma display, or other suitable display technologies. In at least one embodiment, user input is received from input devices 908 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 904 and/or secondary storage. Computer programs, if executed by one or more processors, enable system 900 to perform various functions in accordance with at least one embodiment. memory 904, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 902; parallel processing system 912; an integrated circuit capable of at least a portion of capabilities of both CPU 902; parallel processing system 912; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 900 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 912 includes, without limitation, a plurality of parallel processing units (“PPUs”) 919 and associated memories 916. In at least one embodiment, PPUs 919 are connected to a host processor or other peripheral devices via an interconnect 918 and a switch 920 or multiplexer. In at least one embodiment, parallel processing system 912 distributes computational tasks across PPUs 919 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 919, although such shared memory may incur performance penalties relative to use of local memory and registers resident to a PPU 919. In at least one embodiment, operation of PPUs 919 is synchronized through use of a command such as_syncthreads( ), wherein all threads in a block (e.g., executed across multiple PPUs 919) to reach a certain point of execution of code before proceeding.

The switches within each layer (e.g., edge layer, aggregation layer, core layer) may be 1U switches, where "1U" refers to the industry-standard size for rack-mounted switches and servers. The switches may be electrical switches, optical switches, hybrid electro-optical switches, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch.

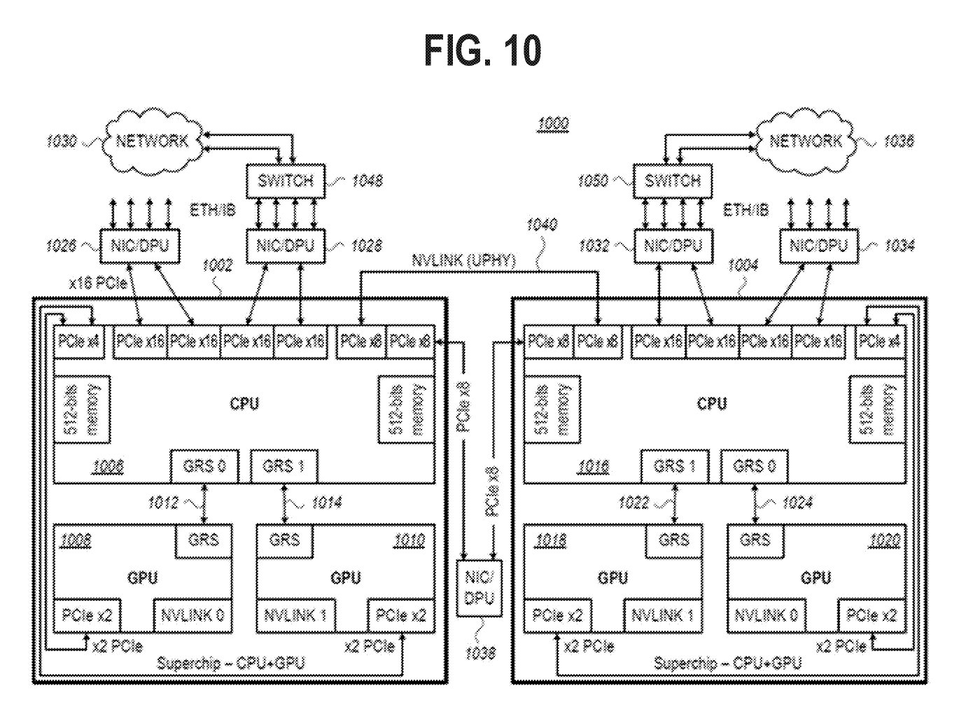

FIG. 10 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs, data processing units (DPUs), quantum processing units (QPUs), a plurality of parallel processing units (PPUs), and application-specific integrated circuits (ASICs). QPUs configured to perform one or more operations associated with a quantum algorithm In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

FIG. 10 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 13, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 14, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 13 may comprise, for example, Nvidia Quantum-2 switches. The NICs/DPUs in the figure may comprise, for example, Nvidia Bluefield DPUs.

In various embodiments, any of the network devices of system 1000, e.g., any of NICs/DPUs 1026, 1028, 1032, 1034, and 1038, and/or any of switches 1048 and 1050, may include electrical components in accordance with various embodiments.

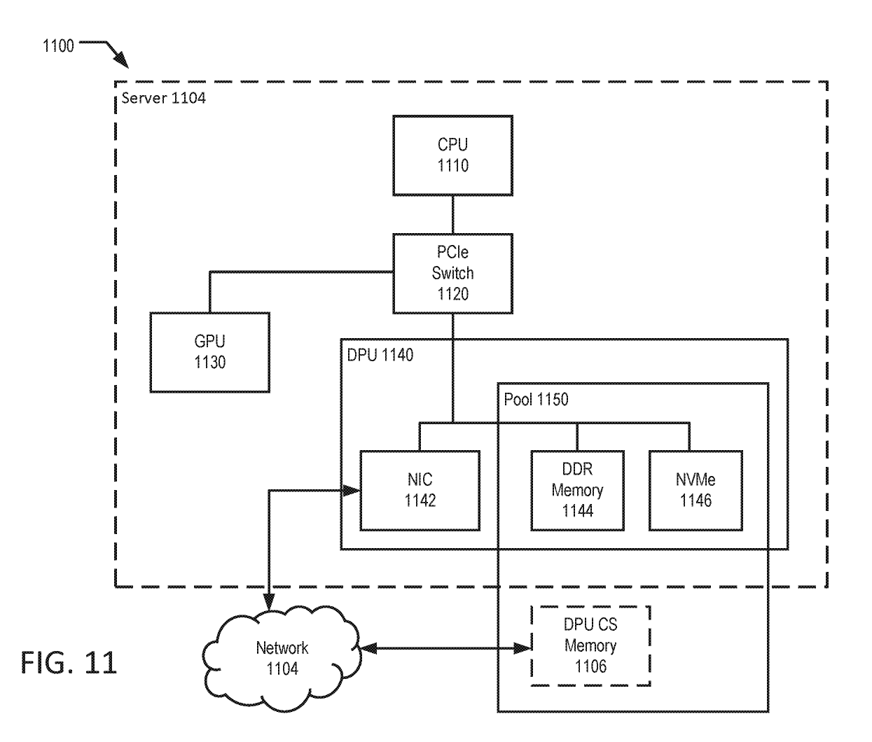

FIG. 11 illustrates an example computing environment 1100 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 1100 may include a server 1102 which may be used to perform HPC workloads, such as AI training or machine learning model training. In an embodiment, the server 1102 may be an application instance or a compute node. The server 1102 may include a CPU 1110 associated with a switch 1120, such as a peripheral component interconnect express (PCIe) switch, which may control at least some data transmission over communication paths interconnecting various components. In an embodiment, the CPU 1110 may include a root complex processor.

The PCIe switch 1120 may also be associated with a GPU 1130 and a DPU 1140, and may transmit data between at least some of the CPU 1110, the GPU 1130, the DPU 1140, and other components. In an embodiment, the PCIe switch 1120 may be associated with more than one GPU or more than one DPU. In another embodiment, the PCIe switch 1120 may be located within the DPU 1140. The PCIe switch 1120 may manage the transfer of at least some data between the CPU 1110, the GPU 1130, and the DPU 1140. In another embodiment, the number of GPUs associated with the PCIe switch 1120 may be equal to the number of DPUs associated with the PCIe switch 1120. In at least one embodiment, the server 1102 may include, without limitation, any number of the CPUs 1110, the PCIe switches 1120, the GPUs 1130, and/or the DPUs 1140, in any combination. For example, in at least one embodiment, server 1102 could include eight, sixteen, thirty-two, and/or more GPUs 1130. In at least one embodiment, communication paths interconnecting various components, including but not limited to the CPU 1110, the PCIe switch 1120, the GPU 1130, and the DPU 1140, in FIG. 14 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 1140 may include a network interface controller (NIC) 1142, a DDR memory 1144, and a non-volatile memory express (NVMe) device 1146. The NIC 1142 may be able to interface with a network 1104, which may also interface with additional NVMe devices available to the DPU 1140, such as over fabric. In an embodiment, the DPU 1140 may not include the NVMe device 1146. In another embodiment, the NVMe device 1146 may be located on the server 1102 and not on the DPU 1140. In yet another embodiment, the computing environment 1100 may include more than one of the NVMe device 1146, such as a first NVMe device in the DPU 1140 and a second first NVMe device on the server 1102 an associated directly with the PCIe switch 1120. In an embodiment, the DPU 1140 may not include the DDR memory 1144 and may include a computational storage services (CSS) in place of, or in addition to, the DDR memory 1144. For example, computing environment 1100 may include DPU computational storage (CS) memory 1106 available to the DPU 1140 as part of the CSS. The network 1104 may be able to interface with the DPU CS memory 1106 through the NIC 1142, according to any suitable interface protocol, such as remote direct memory access (RDMA) over Ethernet, InfiniBand, Fiber Channel, etc.

The total memory of the computing environment 1100 available for data storage may be expanded through the use of the DPU 1140 on nodes of the system. The DPU 1140 may have access to a pool 1150 of memory already available to the server 1102, such as double data rate (DDR) memory, on-board NVMe devices, NVMe devices over fabric, and CS. The pool 1150 of memory may include at least one of the DDR memory 1144, NVMe device 1146, and the DPU CS memory 1106. The DPU 1140 may also be able to access the available memory of other DPUs as part of the pool 1150, and other DPUs may be able to access the available memory of DPU 1140, such as the pool 1150. This available memory can be accessed and utilized for data storage, without the addition of compute resources, such as compute nodes, which would be required using other solutions. The available pool 1150 accessible to the DPU 1140 may be provisioned for the server 1102 to expand the total memory available for data storage, such as to reduce the data storage load on the CPU 1110 or the GPU 1130, which can instead increase the utilization of their memory for processing. For example, during training of an AI, the model states, residual states, activation functions, and checkpoints can be stored, or offloaded, on the pool 1150 accessible to the DPU 1140.

### Multichip-Module (MCM) Assembly

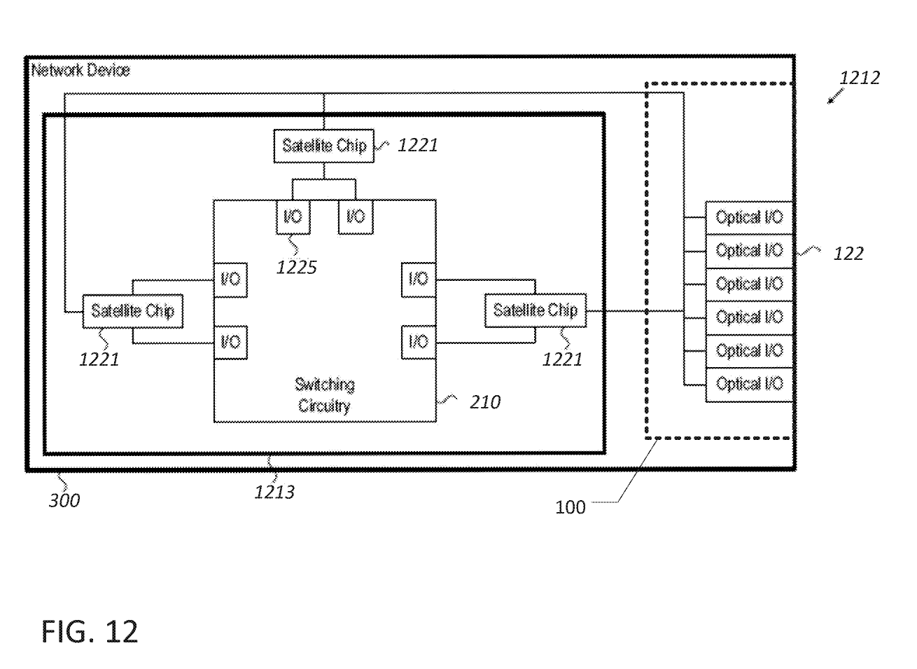

FIG. 12 is a block diagram that schematically illustrates a co-packaged Networking Device (e.g., including one or more CPO shuffle-tray assemblies, switchboards, or chips) within a CPO shuffle tray assembly such as a switch tray 320 or other optical I/O switch tray, in accordance with an embodiment that is disclosed herein. In some embodiments, the different chips that constitute a co-packaged Networking Device are assembled on a single substrate in what is typically called the MCM assembly 1213, or alternatively, a plurality of substrates are provided in a co-packaged Networking Device within a CPO switch tray 320 that each support multiple chips thereon (e.g., collectively encompassing a plurality of MCM assemblies). The MCM assembly 1213 can include a switching circuitry embodying the computing resources 325 (embodying computing resources) surrounded by peripheral or satellite chips 1221. In some embodiments, the switching circuitry embodying the computing resources 325 and surrounding satellite chips 1221 are all mounted on a common substrate, although such a configuration is not required. The MCM assembly 1213 may be provided in a larger housing of the networking device 1212, positioned behind the front panel 126. The switching circuitry embodying the computing resources 325 may include one or more core digital Application Specific Integrated Circuits (ASICs), CPUs, GPUs, microprocessors, FPGAs, combinations thereof, and the like. The switching circuitry embodying the computing resources 325 may include a number of input ports and/or output ports. The Input/Output (I/O) ports 1225 may include electrical ports and/or optical ports. Additionally, the switching circuitry embodying the computing resources 325 may include a combination of electrical blocks and optical blocks. The electrical blocks of the switching circuitry embodying the computing resources 325 may include a number of electrical switches that are configured to route signals in an electrical domain. The optical blocks of the switching circuitry embodying the computing resources 325 may include a number of optical components that are configured to generate, detect, and route signals in an optical domain. The MCM assembly 1213, in some embodiments, may concern or include multiple satellite chips 1221 that are assembled on the same substrate as the switching circuitry embodying the computing resources 325. In some embodiments, a configuration of the optical block(s) and a configuration of the electrical block(s) depends (e.g., is based on) on the number of optical ports in the I/O ports 1225.

First optical connection mating components 122, which may also be referred to as optical connectors, are placed at the front panel 126. As mentioned above, connectivity between the MCM assembly 1213 and first optical connection mating components 122 may be transferred to the front panel 126 through optical fibers. This connection may be made directly with a first optical connection mating component 122 of the switching circuitry or may be made with one or more of the satellite chips 1221. The connection is often made with one or more of the satellite chips 1221 because the satellite chips 1221 may include the electro-optic converters and, possibly, the SERDES to natively support the connection. The satellite chips 1021 may include one or more of aDSP processor, driver, trans-impedance amplifier, laser, modulator, photodiode, serializer-deserializer, or the like.

Some embodiments of the present disclosure are directed to a multi-chip module (MCM) with a centrally positioned main die and a plurality of peripherally positioned MCM sockets configured to mechanically receive and electrically connect mezzanine packages, which may include co-packaged optics (CPO) packages and co-packaged copper (CPC) packages. Each mezzanine package may include a package substrate including a connector portion that is configured to engage the MCM socket and a main portion extending beyond the periphery of the MCM substrate. The main portion of the mezzanine package may be configured to receive optical devices and/or integrated circuits, such as via mezzanine sockets, to allow connections to be made between the optical devices and/or integrated circuits/RF copper cable connectors and the main die of the MCM. Due to the extension of the mezzanine package beyond the periphery of the MCM substrate, the physical size of the MCM substrate may remain small to reduce cost and avoid the previously discussed production challenges, while allowing connections to a number of optical devices and integrated circuits via the mezzanine packages, which occupy the relatively inexpensive space around the periphery of the MCM substrate. As used herein, the terms “co-packaged optic” (or “CPO”) and “co-packaged copper” (or “CPC”) may refer to an advanced heterogeneous integration of either optics and silicon or copper and silicon, in which either integration may be implemented on a single packaged substrate. The CPO may utilize pluggable optical modules that include an optical engine (OE) to convert optical signals to electrical signals and electrical signals to optical signals. The CPO may further be comprised of an optical component on a photonics die and an electrical component on an electrical die.

As used herein, a ball grid array (BGA) may be a type of surface-mount packaging used for integrated circuits. BGA packages use an array of metallic conductor balls arranged in a grid to permanently mount devices such as microprocessors on a PCB. The metallic conductor balls may then undergo the reflow process described above, wherein the metallic conductor balls may be preheated, then melted to bond the IC to a substrate to form an IC package.

As used herein, the term “flip chip (FC)” may refer to a method for interconnecting dies, such as semiconductor devices, IC chips, integrated passive devices, and microelectromechanical systems (MEMS), to external circuitry with solder bumps that have been deposited onto chip pads. The solder bumps may be deposited onto chip pads on the top side of the wafer during final wafer processing. The chip may be mounted to external circuitry (such as a circuit board or another chip or wafer) by “flipping” the chip, such that the chip's top side faces down and is positioned to allow the pads of the chip to align with matching pads on the external circuit. Solder is reflowed to complete the interconnect.

### Packaging

There are several approaches to integrating electronic and photonic components in a 3D stacked IC, each with its own advantages and trade-offs. One method is monolithic integration, where both electronic and photonic devices are fabricated on the same silicon substrate using CMOS-compatible processes. While this approach offers high integration density and potentially lower cost, it is technically challenging due to the differing material and process requirements for high-performance electronic and photonic components.

A more common method is heterogeneous 3D integration, in which the electronic and photonic components are manufactured separately using optimized process technologies, and then stacked vertically using advanced packaging techniques such as wafer bonding, hybrid bonding, or micro-bump flip-chip assembly. This approach allows each component to be fabricated in its most suitable technology node and offers flexibility in design.

Another widely used method is 2.5D integration, which places electronic and photonic chips side by side on a common silicon interposer. While not a true 3D stack, this approach still provides many of the benefits of integration, such as shorter interconnect lengths and increased bandwidth, and is often easier to implement from a thermal and manufacturing perspective. In the packaging of integrated circuit (IC) chips, various packaging schemes are employed, including traditional two-dimensional (2D) integrated circuit (IC) packages as well as the more recently introduced 2.5D IC and 3D IC packages. In 2D IC packages, multiple chips are mounted on a printed circuit board, where high-performance logic, lower-performance logic, memory, and analog/RF functions, and other functional elements are presented as discrete devices in separate chip packages. By contrast, in 2.5D ICs and 3D IC packages, multiple IC chips are mounted on a silicon interposer instead of a conventional package substrate. The silicon interposer, which is typically a silicon wafer, allows very small and high-density conductive traces to be formed between the multiple IC chips because the fabrication processes used to form the conductive traces are the same processes used to form the metal interconnects in the metalization layers of a silicon chip.

Compared to 2.5D IC packages and 3D IC packages, a circuit board with individually packaged chips, such as a 2D IC package, has numerous disadvantages. For example, a 2D IC package is generally larger, heavier, consumes more power, and, because the signals propagate relatively slowly across the circuit board from one chip to another, is slower than an equivalent 2.5D or 3D IC package. Furthermore, a 2D IC package has more possible points of failure, given that the soldered joints on the circuit board are more likely to fail than the electrical connections formed within an interposer. That said, troubleshooting a 2D IC package after the different chips have been mounted on the circuit board is relatively straightforward. In particular, the conductive traces carrying I/O signals between the various chips on the circuit board are easily accessible and therefore can be employed to measure specific I/O signals during troubleshooting.

By contrast, troubleshooting a 2.5D or 3D IC package is far more problematic because the I/O signals transmitted between the different chips typically are embedded in the silicon interposer and are not physically accessible. Furthermore, because 2.5D and 3D IC packages are high-bandwidth and are quite dense, typically implementations can include thousands of conductive traces routed between the different chips. One example of such an implementation is a memory bus residing in between a processor and a high-bandwidth memory chip. In such implementations, even if the traces could be physically accessed through the silicon interposer with a probe, the accurate and reliable selection of a specific conductive trace or combination of conductive traces for the purpose of troubleshooting the IC package would be very difficult, if not impossible.

In at least one embodiment, one or more parallel processor(s) incorporate circuitry optimized for graphics and video processing, including, for example, video output circuitry, and constitutes a graphics processing unit (“GPU”). In at least one embodiment, one or more parallel processor(s) incorporate circuitry optimized for general purpose processing. In at least embodiment, components of computing system may be integrated with one or more other system elements on a single integrated circuit. For example, in at least one embodiment, one or more parallel processor(s), memory hub, processor(s), and I/O hub can be integrated into a SoC integrated circuit. In at least one embodiment, components of computing system can be integrated into a single package to form a system in package (“SIP”) configuration. In at least one embodiment, at least a portion of components of computing system can be integrated into a multi-chip module (“MCM”), which can be interconnected with other multi-chip modules into a modular computing system. In at least one embodiment, I/O subsystem and display devices are omitted from computing system.

In the above description, an embodiment is an example or implementation of the disclosure. The various appearances of "one embodiment,” "an embodiment," "certain embodiments," or "some embodiments" do not necessarily all refer to the same embodiments. Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Certain embodiments of the disclosure may include features from different embodiments disclosed above, and certain embodiments may incorporate elements from other embodiments disclosed above. The disclosure of elements of the disclosure in the context of a specific embodiment is not to be taken as limiting their use in the specific embodiment alone. Furthermore, it is to be understood that the disclosure can be carried out or practiced in various ways and that the disclosure can be implemented in certain embodiments other than the ones outlined in the description above.

The disclosure is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the disclosure belongs, unless otherwise defined. While the disclosure has been described with respect to a limited number of embodiments, these should not be construed as limitations on the scope of the disclosure, but rather as exemplifications of some of the preferred embodiments. Other possible variations, modifications, and applications are also within the scope of the disclosure. Accordingly, the scope of the disclosure should not be limited by what has thus far been described, but by the appended claims and their legal equivalents.

1. An optical connector box comprising:
a plurality of first optical connection mating components;
a plurality of second optical connection mating components;
a plurality of optical fibers each configured to place a respective channel of a first optical connection mating component of the plurality of first optical connection mating components with a respective channel of a second optical connection mating component of the plurality of second optical connection mating components; and
a cassette housing comprising a front panel, a back panel that is opposite the front panel, and defining a volume disposed between the front panel and the back panel,
wherein the plurality of first optical connection mating components are disposed on the front panel, the plurality of second optical connection mating components are disposed on the back panel, and the plurality of optical fibers are disposed within the volume.

2. The optical connector box of claim 1, wherein the plurality of first optical connection mating components are arranged as one or more first aligned columns of connection mating components on the front panel and the plurality of second optical connection mating components are arranged as one or more second aligned columns of connection mating components on the back panel.

3. The optical connector box of claim 2, wherein the one or more first aligned columns of connection mating components defines a first direction and the front panel has a width in a direction perpendicular to the first direction that is at most 20 mm.

4. The optical connector box of claim 1, wherein the plurality of second optical connection mating components are blind mate connectors.

5. The optical connector box of claim 1, wherein the plurality of first optical connection mating components comprises a plurality of multi-fiber push on (MPO) connectors and the plurality of second optical connection mating components comprises a plurality of MXC connectors.

6. The optical connector box of claim 1, wherein the plurality of second optical connection mating components is configured for being placed into optical communication with respective optical backplanes of one or more computing resource trays.

7. A co-packaged optics (CPO) shuffle-tray assembly comprising:
one or more trays, each tray (a) hosting a computing resource and (b) one or more optical backplane mating connectors; and
one or more shuffle cassettes, wherein a shuffle cassette of the one or more shuffle cassettes comprises:
a plurality of first optical connection mating components;
a plurality of second optical connection mating components;
a plurality of optical fibers each configured to place a respective channel of a first optical connection mating component of the plurality of first optical connection mating components with a respective channel of a second optical connection mating component of the plurality of second optical connection mating components; and
a cassette housing comprising a front panel, a back panel that is opposite the front panel, and defining a volume disposed between the front panel and the back panel,
wherein the plurality of first optical connection mating components are disposed on the front panel, the plurality of second optical connection mating components are disposed on the back panel, and the plurality of optical fibers are disposed within the volume,
wherein the one or more optical backplane mating connectors of the one or more trays are configured to mate with respective second optical connection mating components of the plurality of second optical connection mating components.

8. The CPO shuffle-tray assembly of claim 7, wherein each tray of the one or more trays is electrically, optically, and mechanically independent from a remainder of the one or more trays and the one or more shuffle cassettes are configured to place respective computing resources of the one or more trays into optical communication with the plurality of first optical connection mating components.

9. The CPO shuffle-tray assembly of claim 7, wherein the one or more trays are configured to be aligned with one another in a tray column arranged in a first direction, each of the one or more shuffle cassettes are aligned with the tray column, and the one or more shuffle cassettes are arranged in a cassette row aligned in a second direction that is perpendicular to the first direction.

10. The CPO shuffle-tray assembly of claim 7, wherein the one or more trays are configured to be aligned with one another in tray column in a first direction such that the one or more optical backplane mating connectors of the one or more trays are arranged into one or more columns of optical backplane mating connectors.

11. The CPO shuffle-tray assembly of claim 10, wherein the plurality of second optical connection mating components of the shuffle cassette of the one or more shuffle cassettes are arranged in one or more columns of optical connection mating components with one or more columns oriented in the first direction.

12. The CPO shuffle-tray assembly of claim 7, further comprising an assembly housing comprising:
a first sidewall;
a second sidewall; and
a floor component mechanically coupling the first sidewall and the second sidewall, wherein the first sidewall, the second sidewall, and the floor component define an interior of the assembly housing,
wherein the one or more trays are configured to be stacked in a first portion of the interior of the assembly housing such that busbar connectors of the one or more trays extend out from the interior of the assembly housing,
wherein the one or more shuffle cassettes are configured to be disposed in a second portion of the interior of the assembly housing.

13. The CPO shuffle-tray assembly of claim 12, wherein at least one tray comprises one or more cooling ports disposed along a same edge of the at least one tray as a busbar connector of the at least one tray and the assembly housing is configured to enable access to the one or more cooling ports.

14. The CPO shuffle-tray assembly of claim 12, wherein the assembly housing, the one or more shuffle cassettes, and the one or more trays are configured such that each tray of the one or more trays is removable from the assembly housing without removing any of the one or more shuffle cassettes and without removing any other trays from the assembly housing and without un-mating a second optical connection mating component-optical backplane mating connector connections of any other of the one or more trays.

15. The CPO shuffle-tray assembly of claim 12, wherein the assembly housing, the one or more shuffle cassettes, and the one or more trays are configured such that each shuffle cassette of the one or more shuffle cassettes is removable from the assembly housing without removing any of the one or more trays and without removing any other shuffle cassettes from the assembly housing and without un-mating a second optical connection mating component-optical backplane mating connector connections of any other of the one or more shuffle cassettes.

16. The CPO shuffle-tray assembly of claim 12, wherein at least one tray of the one or more trays comprises an extension portion that extends into the second portion of the interior of the assembly housing and the extension portion of the at least one tray extends between two sets of shuffle cassettes.

17. The CPO shuffle-tray assembly of claim 16, wherein the extension portion of the at least one tray comprises a user interface and the user interface comprises one or more indicator lights.

18. The CPO shuffle-tray assembly of claim 12, wherein the assembly housing is configured to enable the shuffle cassette of the one or more shuffle cassettes to be independently slid out of the assembly housing and/or to enable the tray of the one or more trays to be independently slid out of the assembly housing.

19. The CPO shuffle-tray assembly of claim 7, wherein the computing resource is an ASIC and/or the CPO shuffle-tray assembly is an ASIC switch.

20. A datacenter comprising:
one or more CPO shuffle-tray assemblies, wherein each of the one or more CPO shuffle-tray assemblies comprises:
one or more trays, each tray (a) hosting a computing resource and (b) one or more optical backplane mating connectors; and
one or more shuffle cassettes, each of the one or more shuffle cassettes comprising:
a plurality of first optical connection mating components;
a plurality of second optical connection mating components;
a plurality of optical fibers each configured to place a respective channel of a first optical connection mating component of the plurality of first optical connection mating components with a respective channel of a second optical connection mating component of the plurality of second optical connection mating components; and
a cassette housing comprising a front panel, a back panel that is opposite the front panel, and defining a volume disposed between the front panel and the back panel,
wherein the plurality of first optical connection mating components are disposed on the front panel, the plurality of second optical connection mating components are disposed on the back panel, and the plurality of optical fibers are disposed within the volume,
wherein the one or more optical backplane mating connectors of the one or more trays are configured to mate with respective second optical connection mating components of the plurality of second optical connection mating components.
